(19) United States
(12) Patent Application Publication
(10) Pub. No.: US 2023/0410101 A1
(43) Pub. Date: Dec. 21, 2023

(54) BLOCKCHAIN

(71) Applicant: Cambridge Cryptographic Ltd, London (GB)

(72) Inventors: Ying CHAN, Cambridge (GB); John FLETCHER, London (GB)

(73) Assignee: Cambridge Cryptographic Ltd, London (GB)

(21) Appl. No.: 18/031,367

(22) PCT Filed: Oct. 12, 2021
(86) PCT No.: PCT/GB2021/052638

§ 371 Date: Apr. 12, 2023

(30) Foreign Application Priority Data
Oct. 12, 2020 (GB) 2016187.3

(51) Int. Cl. G06Q 20/38; G06Q 20/40

(52) U.S. Cl. CPC G06Q 20/389; G06Q 20/401

(57) ABSTRACT

There is disclosed a computer-implemented method of proposing a block for addition to a first blockchain, the method comprising: identifying a block of a second blockchain; and including in a proposal block for the first blockchain a reference to the identified block of the second blockchain only when: the identified block of the second blockchain extends the second blockchain; and/or the identified block of the second blockchain exceeds a threshold probability of finality; and proposing the proposal block for addition to the first blockchain.

### FIELD OF INVENTION

The present invention relates to a method of configuring a blockchain as well as a method of proposing a block for addition to a blockchain and also a blockchain. Furthermore, the invention extends to apparatuses and systems for carrying out the aforementioned methods and for accessing and configuring the blockchain.

### BACKGROUND

A blockchain is an electronic ledger on which data can be stored. Specifically, a blockchain comprises a plurality of blocks, with each block containing its own list of one or more records. Each block also contains a reference to (e.g. a cryptographic hash of) the previous block so that there exists an unbroken link running through the entirety of the blockchain, with each block referring to the preceding block. Modifying any of the constituent blocks of the blockchain affects the cryptographic hash, so that any modification of a past block is immediately apparent.

Each block of the blockchain comprises a number of records, where each block typically comprises transactions between entities on the blockchain. In order for a transaction to be included in a block and added to the blockchain this transaction must be verified. Verification comprises checking that the transaction meets certain requirements. As an example, in typical implementations of blockchains an amount of a digital asset is locked based on a public key; in order to unlock and spend this digital asset an entity must provide proof that they hold a corresponding private key. The testing of this proof forms a part of the verification process, where a transaction relating to the locked digital asset will not be verified until the requisite proof is provided. Once the transaction has been verified it can be included in a block which is proposed, e.g. by a miner, for addition to the blockchain. This block can then be propagated throughout the system where it is validated (e.g. the validity of the transactions and the mining process is confirmed) by further nodes.

There are a number of factors that must be considered when scaling a blockchain; for example:
Storage capacity: e.g. the number of transactions that can be included in a block of the blockchain. Increasing the storage capacity of a block increases the number of transactions that can be added to the blockchain per block, but could discourage smaller parties from attempting the verification, mining, and validation processes (since processing hugely large blocks might require specialist/expensive equipment). This can lead to undesirable centralisation of mining and validation, where these processes are performed primarily by only a few parties (those with access to the requisite equipment).
Network bandwidth: the communication speed between nodes forms a limit to the amount of transactions that can be validated. Since miners generally wish to work on the current/longest blockchain, it is important that any modifications to the blockchain (e.g. the addition of a block) are quickly communicated and validated. This issue becomes more pronounced if, for example, the size of blocks or the rate of addition of blocks is increased.
Validation throughput: the number of transactions per second that are considered valid by a majority of nodes of the blockchain can be increased by increasing the size of the blocks being added to the blockchain increases the number of transactions per block. However, this also increases the computing load placed on validating nodes and can dissuade potential validators from joining the blockchain (or even cause existing validators to leave). A reduction in the number of validators of the blockchain can lead to an increase in centralisation.

### SUMMARY OF THE DISCLOSURE

Aspects and embodiments of the present invention are set out in the appended claims. These and other aspects and embodiments of the invention are also described herein.

### Simple Block Verification

According to an aspect of the present disclosure, there is described: a computer-implemented method of proposing a block for addition to a first blockchain, the method comprising: identifying a block of a second blockchain; and including in a proposal block for the first blockchain a reference to the identified block of the second blockchain only when (e.g. in dependence on): the identified block of the second blockchain extends the second blockchain; and/or the identified block of the second blockchain exceeds a threshold probability of finality; and proposing the proposal block for addition to the first blockchain.

Preferably, the method is performed by a first node of the first blockchain and/or the method comprises transmitting the proposal block to a second node of the first blockchain.

Preferably, the method is a method of outputting a transmission (e.g. a proposal block) from a first node of a first blockchain to a second node of the first blockchain.

According to an aspect of the present disclosure, there is described: a computer-implemented method of outputting a transmission to a second node of a first blockchain, the method being performed by a first node of the first blockchain, the method comprising: identifying a block of a second blockchain; and including in a proposal block for the first blockchain a reference to the identified block of the second blockchain only when: the identified block of the second blockchain extends the second blockchain; and/or the identified block of the second blockchain exceeds a threshold probability of finality; and outputting a transmission to the second node so as to propose the proposal block for addition to the first blockchain.

Preferably, the method further comprises: transmitting the proposal block to one or more other nodes, preferably one or more nodes of the first blockchain; and/or outputting the proposal block, information relating to the proposal block, and/or a transaction of the proposal block.

Preferably, determining that the identified block extends the second blockchain comprises determining that the identified block is a descendent of a block of the second blockchain previously referenced in the first blockchain. Preferably, determining that the identified block is an immediate descendent of the previously referenced block.

Preferably, including a reference comprises including one or more of: a header of the identified block; one or more transactions included in the identified block; every transaction in the identified block; one or more state transaction functions in the identified block; the entirety of the body of the identified block; the entirety of the identified block; a cryptographic commit of the identified block and a hash of the identified block.

Preferably, the method comprises including in the block of the first blockchain one or more references such that each block of the second blockchain is referenced by, and/or contained in, the first blockchain.

Preferably, the threshold probability of finality relates to a depth of the identified block in the second blockchain. Preferably, the node includes the reference only when the identified block is at least three blocks, at least five blocks, at least six blocks, at least seven blocks, and/or at least ten blocks deep in the second blockchain.

Preferably, the threshold probability of finality relates to a stake held by signatories of the identified block. Preferably, the node includes the reference only when the identified block comprises signatures relating to a stake of, and/or a high probability of a stake of, at least one third, at least one half, and/or at least two thirds.

Preferably, the threshold probability of finality relates to a probability of a block not being orphaned, preferably at least a 90%, at least a 95%, at least a 99%, and/or at least a 99.9% probability that the identified block will not be orphaned.

Preferably, the method further comprises determining that a value relating to, e.g. a hash of, the header of the identified block meets a difficulty threshold and/or that signatures in the header of the identified block meet a stake threshold.

Preferably, including the reference in the first blockchain comprises including the reference in dependence on, and/or in relation to, an identifier in the first blockchain. Preferably, the identifier relates to a smart contract and/or an account on the first blockchain

Preferably, the first blockchain is based on proof of work and/or the second blockchain is based on proof of stake. Preferably, the first blockchain is based on Bitcoin (such as Bitcoin SV).

Preferably, the node receives a reward for the inclusion of the reference.

Preferably, the reward relates to the first blockchain and/or the second blockchain; and/or the reward comprises an amount of a cryptocurrency relating to the first blockchain and/or the second blockchain.

Preferably, identifying the block of the second blockchain comprises one or more of: receiving an indication of the block from a node of the second blockchain; and identifying a block of the second blockchain that exceeds a threshold probability of finality.

Preferably, the method further comprises verifying and/or checking a feature of the identified block. Preferably, the verifying and/or checking comprises one or more of: comparing a value in the header of the identified block to a value relating to one or more transactions in the identified block; comparing a value in the header of the identified block to a value obtained by forming a Merkle tree of the transactions in the identified block; verifying the validity of a transaction in the identified block; verifying a sequence number and/or identifier of the identified block; checking a timestamp of the identified block; and checking a proposer and/or validator of the identified block.

Preferably, some or all of the consensus rules and/or some or all of the transaction requirements for the second blockchain are defined in the first blockchain.

Preferably, the method further comprises updating the consensus rules for the second blockchain in dependence on a block of the second blockchain and/or the first blockchain.

Preferably, the method comprises including in the proposed block a feature relating to the validity of a block and/or transaction of the second blockchain.

Preferably, the feature comprises one or more of: transaction rules; consensus rules; a transaction; a smart contract; and an indication of a legitimate block and/or fork of the second blockchain. Preferably, the legitimate block and/or fork comprises a block and/or fork of the second blockchain that is recorded on the first blockchain.

According to an aspect of the present disclosure, there is described a computer-implemented method of configuring a second blockchain such that before a block is proposed by a node for addition to the second blockchain, the node (e.g. is required to): identifies a feature of a first blockchain; and determines the validity of the proposed block and/or the validity of a transaction of the proposed block based on the feature of the first blockchain.

Preferably, the feature comprises one or more of: transaction rules; consensus rules; a transaction; a smart contract; and an indication of a legitimate block and/or fork of the second blockchain. Preferably, the legitimate block and/or fork comprises a block and/or fork of the second blockchain that is recorded on the first blockchain.

Preferably, the method comprises identifying a transaction on the second blockchain and including a transaction in the proposed block in dependence on the transaction on the second blockchain.

Preferably, identifying a transaction on the second blockchain comprises identifying a transaction in the identified block.

Preferably, the transaction on the second blockchain comprises a reference to the first blockchain and/or a block of the first blockchain.

Preferably, the transaction relates to a transfer between the first blockchain and the second blockchain, preferably a transfer of an asset.

Preferably, the method comprises including a transaction in the proposed block relating to the second blockchain, wherein the transaction is arranged to cause a further transaction on the second blockchain. Preferably, the further transaction relates to the release and/or minting of an asset on the second blockchain.

Preferably, the further transaction on the second blockchain is arranged to cause a yet further transaction on the first blockchain.

Preferably, the method comprises executing a function defined on the first blockchain based on information in the identified block of the second blockchain.

### Migration

Preferably, the method further comprises determining migration information relating to the second blockchain.

Preferably, the method further comprises determining the migration information by evaluating the identified block of the second blockchain.

Preferably, the method further comprises including in the proposal block migration information relating to the second blockchain.

According to an aspect of the present disclosure, there is described a computer-implemented method of proposing a block for addition to a first blockchain, the method comprising: determining migration information relating to a second blockchain.

According to an aspect of the present disclosure, there is described: a computer-implemented method of outputting a transmission to a second node of a first blockchain, the method being performed by a first node of the first blockchain, the method comprising: determining migration information relating to a second blockchain; and outputting the migration information to the second node.

Preferably, the method comprises determining the migration information by evaluating a block of the second blockchain; including the migration information in a proposal block for the first blockchain; and proposing the proposal block for addition to the first blockchain.

Preferably, the migration information comprises a flag.

Preferably, the first blockchain and/or the second blockchain comprises a mechanism for activating the flag. Preferably, activating the flag comprises including the flag in a block of the second blockchain.

Preferably, the nodes of the first blockchain and/or the second blockchain are able to activate the flag.

Preferably, the nodes of the first blockchain are able to identify the flag in a block of the first blockchain and/or the second blockchain.

Preferably, the presence of the flag enables a node of the first blockchain to process transactions relating to the second blockchain. Preferably, the node of the first blockchain is arranged to include transactions relating to the second blockchain in the proposed block.

Preferably, the presence of the flag configures the second blockchain, and/or a node of the second blockchain, to only record transactions via the first blockchain.

Preferably, the presence of the flag configures the second blockchain, and/or a node of the second blockchain, to no longer allow the addition of further transactions and/or blocks.

Preferably, the presence of the flag alters the consensus rules for the second blockchain.

Preferably, the presence of the flag upon activation and/or identification of the flag the second blockchain, and/or a node of the second blockchain, is configured to lock each asset relating to the second blockchain.

Preferably, the presence of the flag upon activation and/or identification of the flag the first blockchain, and/or a node of the first blockchain, is configured to release assets relating to assets stored on the second blockchain.

Preferably, the presence of the flag upon activation and/or identification of the flag the first blockchain and the second blockchain, and/or a node of the first blockchain and/or second blockchain, are configured so that assets relating to the second blockchain are transferred to the first blockchain.

Preferably, the method comprises determining one or more groups relating to the second blockchain in dependence on the migration information.

Preferably, the method comprises including in the proposal block a transaction relating to the transfer an asset from the second blockchain to the first blockchain in dependence on the asset relating to one of the groups. Preferably, the block of the first blockchain in which the asset is transferred is dependent on the group.

Preferably, the method comprises determining the validity of a transaction and/or a block of the second blockchain in dependence on the group. Preferably, the node is arranged to only validate blocks comprising transactions relating to a subset of the groups.

Preferably, the second blockchain, and/or a node of the second blockchain, is configured to monitor the first blockchain and/or to record on the second blockchain transactions relating to the second blockchain that are recorded on the first blockchain.

### Recoverability

Preferably, the method comprises including in the proposal block information identifying a legitimate block and/or fork of the second blockchain.

According to an aspect of the present disclosure, there is described a computer-implemented method of configuring a second blockchain to monitor a first blockchain such that, before a block is proposed for addition to the second blockchain by a node, the node: identifies a legitimate block and/or fork of the second blockchain based on information recorded in the first blockchain.

According to an aspect of the present disclosure, there is described: a computer-implemented method of outputting a transmission to a second node of a first blockchain, the method being performed by a first node of the first blockchain, the method comprising: identifying a legitimate block and/or fork of the second blockchain based on information recorded in the first blockchain; and outputting the legitimate block and/or fork to the second node.

Preferably, the method comprises receiving an invalidity proof relating to a transaction and/or block of the second blockchain; and including in the proposal block information relating to the invalidity proof.

Preferably, the invalidity proof comprises one or more of: evidence of a falsified transaction; evidence of a double-spend; evidence of a falsified block header; evidence of halting of the second blockchain; a reference to a previous transaction of the second blockchain; a fraud proof; and a reference to a previous transaction and/or block of the second blockchain that is recorded on the first blockchain.

According to an aspect of the present disclosure, there is described a computer-implemented method of proposing a block for addition to a first blockchain, the method comprising: receiving an invalidity proof relating to a transaction and/or block of the second blockchain that is referenced by, and/or recorded on, the first blockchain; and including in a proposal block for the first blockchain information relating to the invalidity proof; and proposing the proposal block for addition to the first blockchain.

According to an aspect of the present disclosure, there is described: a computer-implemented method of outputting a transmission to a second node of a first blockchain, the method being performed by a first node of the first blockchain, the method comprising: receiving an invalidity proof relating to a transaction and/or block of the second blockchain that is referenced by, and/or recorded on, the first blockchain; and including in a proposal block for the first blockchain information relating to the invalidity proof; and outputting the proposal block to the second node so as to propose the proposal block for addition to the first blockchain.

Preferably, the invalidity proof comprises one or more of: evidence of a falsified transaction; evidence of a double-spend; evidence of a falsified block header; evidence of halting of the second blockchain; a reference to a previous transaction of the second blockchain; a fraud proof; and a reference to a previous transaction and/or block of the second blockchain that is recorded on the first blockchain.

Preferably, the method further comprises determining a challenge period that relates to the invalidity proof and/or to a block of the side chain; and rejecting the invalidity proof when the challenge period has expired.

Preferably, the challenge period relates to the first blockchain.

Preferably, the challenge period relates to a block of the first blockchain that contains the block of the second blockchain, and/or a reference to the block of the second blockchain.

Preferably, the challenge period relates to a probability of finality for, and/or a block depth of, a block of the first blockchain. Preferably, the challenge period relates to a block of the first blockchain that references, and/or includes, the block of the second blockchain not exceeding a block depth of ten blocks, six blocks, and/or four blocks.

Preferably, the challenge period relates to a stake held by the validators of a block of the first blockchain that references, and/or includes, the block of the second blockchain not exceeding ⅔, ½, and/or ⅓.

Preferably, the method further comprises determining a challenge period that relates to the invalidity proof and/or to a block of the side chain; and rejecting the invalidity proof when the challenge period has not yet begun.

Preferably, the challenge period relates to the first blockchain.

Preferably, the challenge period relates to a block of the first blockchain that contains the block of the second blockchain, and/or a reference to the block of the second blockchain.

Preferably, the challenge period relates to a block of the first blockchain that does not contains a block of the second blockchain, and/or a reference to a block of the second blockchain.

Preferably, the challenge period relates to a probability of finality for, and/or a block depth of, a block of the first blockchain.

Preferably, the challenge period relates to a block of the first blockchain that references, and/or includes, the block of the second blockchain not exceeding a block depth of ten blocks, six blocks, and/or four blocks.

Preferably, the challenge period relates to a stake held by the validators of a block of the first blockchain that references, and/or includes, the block of the second blockchain not exceeding ⅔, ½, and/or ⅓.

Preferably, the information comprises recovery information.

Preferably, the recovery information comprises a legitimate block of the blockchain and/or a last legitimate block of the second blockchain.

Preferably, the recovery information comprises an indication of an illegitimate block of the second blockchain.

Preferably, the method further comprises viewing and/or outputting a transaction relating to the second blockchain. Preferably, viewing and/or outputting the transaction comprises identifying the transaction of the second blockchain in a block of the first blockchain.

According to an aspect of the present invention, there is described an apparatus arranged to carry out the method of any preceding claim.

According to an aspect of the present invention, there is described an apparatus arranged to store, access, view, and/or output a transaction of the first blockchain and/or the second blockchain. Preferably, viewing and/or outputting a transaction of the second blockchain comprises identifying the transaction in a block of the first blockchain

Preferably, the apparatus comprises a computer implemented device. Preferably, the apparatus comprises means for presenting information. Preferably, the apparatus comprises a display and/or a speaker.

According to an aspect of the present disclosure, there is described a computer-implemented method of proposing a block for addition to a first blockchain, the method comprising: identifying a block of a second blockchain; and including in a proposal block for the first blockchain the identified block of the second blockchain only when: the identified block of the second blockchain extends the second blockchain; and/or the identified block of the second blockchain exceeds a threshold probability of finality; and proposing the proposal block for addition to the first blockchain.

According to an aspect of the present disclosure, there is described an apparatus arranged: to carry out the method of any preceding claim; and/or to store, access, and/or view the blockchain and/or the public consensus mechanism of any preceding claim. Preferably, the apparatus comprises a computer implemented device. Preferably, the apparatus comprises means for presenting information, preferably a display and/or a speaker.

According to an aspect of the present disclosure, there is described a computer-implemented method of configuring a first blockchain to record information relating to a second blockchain, the method comprising adding information to the first blockchain such that, in order for a node to propose a block for addition to the first blockchain, the node: identifies a block of the second blockchain; and includes in a proposal block for the first blockchain a reference to the identified block of the second blockchain only when: the identified block of the second blockchain extends the second blockchain; and/or the identified block of the second blockchain exceeds a threshold probability of finality; and proposes the proposal block for addition to the first blockchain.

According to an aspect of the present disclosure, there is described computer-implemented method of configuring a second blockchain such that, following the addition of a block to the second blockchain, a node of the second blockchain transmits information to a node of the first blockchain to enable the node of the first blockchain to: identify a block of the second blockchain based on the information; include in a proposal block for the first blockchain a reference to the identified block of the second blockchain only when: the identified block of the second blockchain extends the second blockchain; and/or the identified block of the second blockchain exceeds a threshold probability of finality; and propose the proposal block for addition to the first blockchain.

According to an aspect of the present disclosure, there is described blockchain configured such that in order for a node to propose a block for addition to the blockchain, the node is able to and/or required to: identify a block of a further blockchain; and include in a proposal block for the blockchain a reference to the identified block of the further blockchain only when: the identified block of the further blockchain extends the further blockchain; and/or the identified block of the further blockchain exceeds a threshold probability of finality; and propose the proposal block for addition to the blockchain

According to an aspect of the present disclosure, there is described an apparatus for recording entries on a first blockchain, wherein the apparatus is arranged to: identify a block of a second blockchain; and include in a proposal block for the first blockchain a reference to the identified block of the further blockchain only when: the identified block of the further blockchain extends the further blockchain; and/or the identified block of the further blockchain exceeds a threshold probability of finality; and propose the proposal block for addition to the first blockchain.

According to an aspect of the present disclosure, there is described computer-implemented method of proposing information for addition to a first public consensus network, the method comprising: identifying a piece of information of a second public consensus network; and including in a proposal piece of information for the first public consensus network a reference to the identified piece of information of the second public consensus network only when: the identified piece of information of the second public consensus network extends the second public consensus network; and/or the identified piece of information of the second public consensus network exceeds a threshold probability of finality; and proposing the proposal piece of information for addition to the first public consensus network.

### Simple Block Verification

According to an aspect of the present disclosure, there is described a computer-implemented method of configuring a first blockchain to record information relating to a second blockchain, the method comprising adding information to the first blockchain such that, before a block is proposed for addition to the first blockchain by a node, the node: identifies a block of the second blockchain; and includes in the block for the first blockchain a reference to the identified block of the second blockchain only when: the identified block of the second blockchain extends the second blockchain; and/or the identified block of the second blockchain exceeds a threshold probability of finality.

According to an aspect of the present disclosure, there is described a computer-implemented method of configuring a second blockchain such that, following the addition of a block to the second blockchain, a node of the second blockchain transmits information to a node of the first blockchain to enable the node of the first blockchain to: identify a block of the second blockchain; and include in the block for the first blockchain a reference to the identified block of the second blockchain only when: the identified block of the second blockchain extends the second blockchain; and/or the identified block of the second blockchain exceeds a threshold probability of finality.

According to an aspect of the present disclosure, there is described a computer-implemented method of proposing a block for addition to a first blockchain, the method comprising: identifying a block of a second blockchain; and determining whether: the identified block of the second blockchain extends the second blockchain; and/or the identified block of the second blockchain exceeds a threshold probability of finality; and including in the block for the first blockchain a reference to the identified block of the second blockchain in dependence on the determination.

According to an aspect of the present disclosure, there is described a computer-implemented method of identifying a block of a second blockchain for inclusion in a first blockchain, the method comprising: identifying a block of the second blockchain; transmitting a pointer to the identified block to a node of the first blockchain, such that the node of the first blockchain is able to: determine whether: the identified block of the second blockchain extends the second blockchain; and/or the identified block of the second blockchain exceeds a threshold probability of finality; and including in a block for the first blockchain a reference to the identified block of the second blockchain in dependence on the determination.

According to an aspect of the present disclosure, there is described a blockchain configured such that before a block is proposed for addition to the blockchain by a node, the node is able to and/or required to: identify a block of a further blockchain; and include in the block for the blockchain a reference to the identified block of the further blockchain only when: the identified block of the further blockchain extends the further blockchain; and/or the identified block of the further blockchain exceeds a threshold probability of finality.

According to an aspect of the present disclosure, there is described an apparatus for recording entries on a blockchain, wherein the apparatus is arranged to: identify a block of a further blockchain; and include in the block for the blockchain a reference to the identified block of the further blockchain only when: the identified block of the further blockchain extends the further blockchain; and/or the identified block of the further blockchain exceeds a threshold probability of finality.

According to an aspect of the present disclosure, there is described a computer-implemented method of configuring a first public consensus network to record information relating to a second public consensus network, the method comprising adding information to the first public consensus network such that, before information is proposed for addition to the first public consensus network by a node, the node: identifies a piece of information of the second public consensus network; and includes in the information for the first blockchain a reference to the identified piece of information of the second public consensus network only when: the identified piece of information of the second public consensus network extends the second public consensus network; and/or the identified piece of information of the second public consensus network exceeds a threshold probability of finality.

Preferably, the method further comprises proposing the block for addition to the blockchain.

Preferably, the method further comprises transmitting the block to one or more other nodes, preferably one or more nodes of the blockchain.

Preferably, the method further comprises further comprising outputting the block and/or a transaction of the block.

Preferably, including a reference comprises including one or more of: a header of the identified block; one or more transactions included in the identified block; every transaction in the identified block; one or more state transaction functions in the identified block; the entirety of the body of the identified block; the entirety of the identified block; and a hash of the identified block.

Preferably, the reference is arranged to enable one or more blocks of the second blockchain to be recovered from the first blockchain.

Preferably, the method comprises identifying a plurality of blocks of the second blockchain. Preferably, the method comprises identifying a plurality of blocks of the second blockchain that are not referenced by the first blockchain.

Preferably, the method comprises including in the block for the first blockchain a reference to each of the plurality of identified blocks of the second blockchain only when: each identified block of the second blockchain is a descendent of a block of the second blockchain previously referenced in the first blockchain; and/or each identified block of the second blockchain exceeds a threshold probability of finality.

Preferably, the plurality of blocks comprises a first block that is an immediate descendent of the block previously referenced in the first blockchain. Preferably, the plurality of blocks comprises a second block that is an immediate descendent of the first block.

Preferably, the method comprises including in the block a plurality of references for a plurality of blocks of the second blockchain.

Preferably, the reference relates to a plurality of blocks of the second blockchain.

Preferably, the method comprises including in the block of the first blockchain references such that each block of the second blockchain is referenced by, and/or contained in, the first blockchain.

Preferably, the threshold probability of finality relates to a depth of the identified block in the second blockchain. Preferably, the node is arranged to include the reference only when the identified block is at least three blocks, at least five blocks deep, at least six blocks deep, at least seven blocks deep, and/or at least ten blocks deep in the second blockchain.

Preferably, the threshold probability of finality relates to a stake held by signatories of the identified block.

Preferably, the node includes the reference only when the identified block comprises signatures relating to a stake of at least one third, at least one half, and/or at least two thirds.

Preferably, the threshold probability of finality relates to at least a 90%, at least a 95%, at least a 99%, and/or at least a 99.9% probability that the identified block will not be orphaned.

Preferably, determining that the identified block extends the second blockchain comprises determining that the identified block is a descendent of a block of the second blockchain previously referenced in the first blockchain.

Preferably, the identified block being a descendent of a block of the second blockchain previously referenced in the first blockchain comprises the identified block being an immediate descendent of a block of the second blockchain previously referenced in the first blockchain.

Preferably, the identified block being a descendent of a block of the second blockchain previously referenced in the first blockchain comprises the identified block being a descendent of a block of the second blockchain referenced in a previous block of the first blockchain, preferably the immediately previous block of the first blockchain.

Preferably, the method comprises determining a feature of the identified block that links the identified block to a previous block of the second blockchain. Preferably, the feature comprises one or more of: a header of the identified block; and a hash relating to the previous block.

Preferably, the method comprises analysing one or more of the transactions in the identified block. Preferably, the method comprises comparing a value relating to the transactions in the identified block to a value in the header of the identified block. Preferably, the method comprises comparing a value relating to a Merkle tree of the transactions to the value in the header.

Preferably, the method comprises the reference to the identified block is included in dependence on the analysis.

Preferably, the method further comprises determining that a hash in the header of the identified block meets a difficulty threshold.

Preferably, the method further comprises determining that a number of signatures in the header of the identified block meet a stake threshold.

Preferably, the reference to the identified block is included in dependence on the determination.

Preferably, the method comprises determining a party that is referenced in a header of the identified block. Preferably, the method comprises determining that said party has authority to propose and/or validate the identified block. Preferably, the method comprises determining that said party holds a stake in the second blockchain.

Preferably, wherein identifying a block of the second blockchain comprises identifying a block that exceeds a threshold probability of finality.

Preferably, the threshold probability of finality is dependent on a feature of the second blockchain. Preferably, the threshold probability of finality is dependent on one or more of: a transaction in the second blockchain; a transaction amount in a block the second blockchain; and an anti-sybil mechanism (e.g. the use of proof of stake and/or proof of work) of the second blockchain.

Preferably, including the reference in the first block comprises including the reference in dependence on, and/or in relation to, an identifier in the first blockchain. Preferably, the identifier relates to a smart contract and/or an account on the first blockchain.

Preferably, the identifier is included in a plurality of blocks of the first blockchain.

Preferably, the first blockchain is a proof of work blockchain and/or the second blockchain is a proof of stake blockchain. Preferably, the first blockchain is based on Bitcoin, e.g. the first blockchain may be Bitcoin SV.

Preferably, the method comprises providing a reward for the inclusion of the reference. Preferably, the reward relates to the first blockchain and/or the second blockchain; and/or the reward comprises an amount of a cryptocurrency relating to the first blockchain and/or the second blockchain; and/or the reward is provided to a miner and/or proposer of the identified block.

### Trustless Interoperability

Preferably, some or all of the consensus rules and/or some or all of the transaction requirements for the second blockchain are defined in the first blockchain.

Preferably, a node of the second blockchain is arranged so that before a block is proposed, by a node, for addition to the second blockchain, the node: identifies a feature of a first blockchain; and determines the validity of the proposed block and/or the validity of a transaction of the proposed block based on the feature of the first blockchain.

According to an aspect of the present disclosure, there is described a computer-implemented method of configuring a second blockchain such that before a block is proposed by a node for addition to the second blockchain, the node: identifies a feature of a first blockchain; and determines the validity of the proposed block and/or the validity of a transaction of the proposed block based on the feature of the first blockchain.

According to an aspect of the present disclosure, there is described a computer-implemented method of configuring a first blockchain to include information relating to a second blockchain such that before a block is proposed by a node for addition to a second blockchain, the node: identifies a feature of a first blockchain; and determines the validity of the proposed block and/or the validity of a transaction of the proposed block based on the feature of the first blockchain.

According to an aspect of the present disclosure, there is described a computer-implemented method of proposing a block for addition to a second blockchain, the method comprising: identifying a feature of a first blockchain; determines the validity of the proposed block and/or the validity of a transaction of the proposed block based on the feature of the first blockchain; and proposing the block in dependence on the determination.

According to an aspect of the present disclosure, there is described a computer-implemented method of proposing a block for addition to a first blockchain, wherein the block comprises information relating to a second blockchain such that before a block is proposed by a node for addition to the second blockchain, the node: identifies a feature of a first blockchain; and determines the validity of the proposed block and/or the validity of a transaction of the proposed block based on the feature of the first blockchain.

According to an aspect of the present disclosure, there is described a blockchain comprising information relating to a further blockchain such that before a block is proposed by a node for addition to the further blockchain, the node is able to, and/or required to: identify a feature of the blockchain; and determine the validity of the proposed block and/or the validity of a transaction of the proposed block based on the feature of the blockchain.

According to an aspect of the present disclosure, there is described an apparatus for recording entries on a blockchain, wherein the apparatus is arranged to: identify a feature of a further blockchain; and determine the validity of a proposed block for the blockchain and/or the validity of a transaction of the proposed block based on the feature of the further blockchain.

According to an aspect of the present disclosure, there is described a computer-implemented method of configuring a second public consensus network such that before information is proposed by a node for addition to the second public consensus network, the node: identifies a piece of information on a first public consensus network; and determines the validity of the information and/or the validity of a transaction of the information based on the feature of the first public consensus network.

Preferably, the method further comprises proposing the block for addition to the second blockchain.

Preferably, the method further comprises transmitting the proposed block to one or more other nodes, preferably one or more other nodes of the second blockchain.

Preferably, the method further comprises outputting the proposed block and/or a transaction of the proposed block.

Preferably, the feature comprises one or more of: transaction rules; consensus rules; a transaction; and a smart contract.

Preferably, the feature comprises an indication of a legitimate block and/or fork of the second blockchain.

Preferably, the feature comprises an indication of a last legitimate block of the second blockchain.

Preferably, the legitimate block comprises a block of the second blockchain recorded on the first blockchain.

Preferably, determining the validity comprises determining that the proposed block extends a legitimate fork of the second blockchain, wherein the legitimate fork is defined by the feature of the first blockchain.

### Two Way Peg

Preferably, the method comprises identifying a transaction on the first blockchain and including a transaction on the second blockchain in dependence on the transaction on the first blockchain. Preferably, the transaction on the first blockchain comprises a reference to the second blockchain and/or a block of the second transaction.

Preferably, the method comprises identifying a transaction on the second blockchain and including a transaction on the first blockchain in dependence on the transaction on the second blockchain.

Preferably, the identified transaction relates to a transfer between the first blockchain and the second blockchain. Preferably, the identified transaction relates to a transfer of an asset.

Preferably, the method comprises receiving an invalidity proof relating to the transaction on the first blockchain.

Preferably, the identified transaction is identified based on a feature of the identified transaction. Preferably, the identified transaction is identified based on one or more of: a recipient; a recipient address; and a reference.

Preferably, the method comprises identifying a block comprising the identified transaction. Preferably, the method comprises determining that the identified block surpasses a threshold probability of finality. Preferably, the method comprises determining that the identified block has reached a threshold depth and/or relates to a threshold stake.

Preferably, the method comprises executing a function in relation to the second blockchain based on a block of the first blockchain. Preferably the method comprises executing the function in relation to a block of the second blockchain being proposed for addition to the first blockchain.

Preferably, the method comprises executing a function defined on the first blockchain based on information in the identified block of the second blockchain.

### Migration

Preferably, the first blockchain comprises migration information relating to a second blockchain.

According to an aspect of the present disclosure, there is described a computer-implemented method of configuring a first blockchain, such that: the first blockchain comprises migration information relating to a second blockchain.

According to an aspect of the present disclosure, there is described a computer-implemented method of configuring a second blockchain, such that: the second blockchain is arranged to receive migration information from a first blockchain.

According to an aspect of the present disclosure, there is described a computer-implemented method of configuring a second blockchain such that before a block is proposed by a node for addition to the second blockchain, the node: identifies migration information relating to the second blockchain from a first blockchain.

According to an aspect of the present disclosure, there is described a computer-implemented method of configuring a first blockchain such that before a block is proposed by a node for addition to the first blockchain, the node: includes migration information relating to the second blockchain in the proposed block.

According to an aspect of the present disclosure, there is described a computer-implemented method of proposing a block for addition to a first blockchain, wherein: the first blockchain comprises migration information relating to a second blockchain.

According to an aspect of the present disclosure, there is described a computer-implemented method of proposing a block for addition to a second blockchain, wherein: the second blockchain identifies migration information relating to the second blockchain in a first blockchain; wherein the proposed block is determined based on the migration information.

According to an aspect of the present disclosure, there is described a blockchain comprising migration information relating to a further blockchain.

According to an aspect of the present disclosure, there is described an apparatus for recording entries on a blockchain, wherein the apparatus is arranged to includes migration information relating to the second blockchain in a proposed block for the blockchain.

According to an aspect of the present disclosure, there is described a computer-implemented method of configuring a first public consensus network, such that: the first blockchain comprises migration information relating to a second public consensus network.

Preferably, the method further comprises proposing a block for addition to the first blockchain and/or the second blockchain based on the migration information.

Preferably, the method further comprises transmitting the proposed block to one or more other nodes, preferably one or more other nodes of the first blockchain and/or the second blockchain.

Preferably, the method further comprises outputting the migration information and/or a transaction of the migration information.

Preferably, the migration information comprises a flag. Preferably, the first blockchain and/or the second blockchain comprises a mechanism for activating the flag and/or including the flag in a block of the first blockchain and/or the second blockchain. Preferably, the nodes of the first blockchain and/or the second blockchain are able to activate the flag and/or include the flag in a block of the first blockchain and/or the second blockchain.

Preferably, the flag being activated and/or present enables the first blockchain to process transactions relating to the second blockchain. Preferably, the first blockchain is arranged to record transactions relating to the second blockchain on the first blockchain.

Preferably, the flag being activated and/or present enables the node of the first blockchain to process transactions relating to the second blockchain. Preferably, the node of the first blockchain is arranged to include transactions relating to the second blockchain in the proposed block.

Preferably, the activation and/or inclusion of the flag requires one or more of: the consent of a majority of stakeholders of the second blockchain; the consent of a majority of users of the first blockchain; the consent of a majority of stakeholders of the second blockchain; and/or the consent of a majority of users of the first and second blockchains.

Preferably, the second blockchain is configured to only record transactions via the first blockchain when the flag is activated and/or present.

Preferably, upon activation and/or inclusion of the flag the second blockchain is configured to no longer enable the addition of further transactions and/or blocks.

Preferably, the second blockchain is configured such that the activation and/or presence of the flag alters the consensus rules of the second blockchain.

Preferably, the second blockchain is configured such that the activation and/or presence of the flag results in the second blockchain locking each asset relating to the second blockchain.

Preferably, the first blockchain is configured such that the activation and/or presence of the flag results in the first blockchain releasing assets relating to assets stored on the second blockchain.

Preferably, the first blockchain and the second blockchain are configured such that the activation and/or presence of the flag results in assets relating to the second blockchain being transferred to the first blockchain.

Preferably, the activation of the flag results in the addition of a block to the first blockchain and/or the second blockchain (e.g. by a node of the first blockchain and/or the second blockchain).

Preferably, the activation of the flag results in the node determining one or more groups relating to the second blockchain. Preferably, the activation of the flag results in the node identifying one or more groups of transactions relating to the second blockchain.

Preferably, the method comprises transferring an asset from the second blockchain to the first blockchain in dependence on the asset relating to one of the groups. Preferably, the block of the main chain in which the asset is transferred is dependent on the group.

Preferably, the activation of the flag results in a node of the first blockchain and/or the second blockchain determining the validity of a transaction and/or a block of the second blockchain in dependence on the group. Preferably, the node is arranged to only validate blocks comprising transactions relating to a subset of the groups.

Preferably, the activation of the flag results in the alteration of the consensus rules of the second blockchain and also the transfer of assets from the first blockchain to the second blockchain. Preferably, the consensus rules are altered before the transfer of assets. Preferably, the consensus rules are altered at least one block, at least three blocks, and/or at least six blocks before the transfer of assets. Preferably, the blocks are blocks of the second blockchain.

Preferably, the second blockchain is configured to monitor the first blockchain and/or to record transactions relating to the second blockchain that are recorded on the first blockchain.

### Recoverability

Preferably, the method comprises identifying a legitimate block and/or fork of the second blockchain based on information recorded in the first blockchain

According to an aspect of the present disclosure, there is described a computer-implemented method of configuring a second blockchain to monitor a first blockchain, the method comprising adding information to the first and/or second blockchain such that, before a block is proposed for addition to the second blockchain by a node, the node: identifies a legitimate block and/or fork of the second blockchain based on information recorded in the first blockchain.

According to an aspect of the present disclosure, there is described a computer-implemented method of configuring a first blockchain, the method comprising adding information to the first blockchain such that a node of the second blockchain is capable of: identifying a legitimate block and/or fork of the second blockchain based on information recorded in the first blockchain.

According to an aspect of the present disclosure, there is described a computer-implemented method of proposing a block for addition to a second blockchain, comprising identifies a legitimate block and/or fork of the second blockchain based on information recorded in a first blockchain.

According to an aspect of the present disclosure, there is described a computer-implemented method of proposing a block for addition to a first blockchain, wherein the block: comprises information relating to a legitimate block and/or fork of a second blockchain.

According to an aspect of the present disclosure, there is described a blockchain comprising information relating to a legitimate block and/or fork of a further blockchain.

According to an aspect of the present disclosure, there is described an apparatus for recording entries on a blockchain, wherein the apparatus is arranged to identify a legitimate block and/or fork of the blockchain based on information recorded in a further blockchain.

According to an aspect of the present disclosure, there is described a computer-implemented method of configuring a second public consensus network to monitor a first public consensus network, the method comprising adding information to the first and/or second public consensus network such that, before a block is proposed for addition to the second public consensus network by a node, the node: identifies a legitimate portion and/or fork of the second public consensus network based on information recorded in the first public consensus network.

Preferably, the method further comprises proposing a block for addition to the second blockchain in dependence on the legitimate block and/or fork, preferably proposing a block for addition to the second blockchain in order to extend a/the legitimate fork.

Preferably, the method further comprises transmitting the proposed block to one or more other nodes, preferably one or more other nodes of the second blockchain.

Preferably, the method further comprises outputting information relating to the legitimate block and/or fork.

Preferably, a node of the first blockchain and/or the second blockchain is arranged to receive an invalidity proof relating to a transaction and/or block of the second blockchain.

According to an aspect of the present disclosure, there is described a computer-implemented method of configuring a first blockchain, such that: a node of the first blockchain and/or a second blockchain is arranged to receive an invalidity proof relating to a transaction and/or block of the second blockchain.

According to an aspect of the present disclosure, there is described a computer-implemented method of proposing a block for addition to a first blockchain, comprising: receiving an invalidity proof relating to a transaction and/or block of a second blockchain; proposing the block in dependence on the invalidity proof.

According to an aspect of the present disclosure, there is described a computer-implemented method of proposing a block for addition to a second blockchain, comprising: receiving an invalidity proof relating to a transaction and/or block of the second blockchain; proposing the block in dependence on the invalidity proof.

According to an aspect of the present disclosure, there is described a blockchain comprising an invalidity proof relating to a transaction and/or block of a further blockchain.

According to an aspect of the present disclosure, there is described an apparatus for recording entries on a blockchain, wherein the apparatus is arranged to an invalidity proof relating to a transaction and/or block of a further blockchain.

According to an aspect of the present disclosure, there is described a computer-implemented method of configuring a first public consensus network, such that: a node of the first public consensus network and/or a second public consensus network is arranged to receive an invalidity proof relating to a transaction of and/or information on the second public consensus network.

Preferably, the method further comprises proposing a block for addition to the first blockchain and/or the second blockchain in dependence on the invalidity proof.

Preferably, the method further comprises transmitting the invalidity proof and/or a/the proposed block to one or more other nodes, preferably one or more other nodes of the first blockchain and/or the second blockchain.

Preferably, the method further comprises outputting information relating to the invalidity proof and/or outputting the invalidity proof.

Preferably, the node is arranged to determine a challenge period that relates to the invalidity proof; and reject the invalidity proof when the challenge period related to the invalidity proof has expired.

Preferably, the challenge period relates to one or more of: a probability of finality; a block depth; a stake held by validators of the block.

Preferably, the challenge period relates to the main chain. Preferably, the challenge period relates to a probability of finality for, and/or a block depth of, a block of the main chain.

Preferably, the challenge period for a block of the second blockchain is dependent on a block of the main chain in which a reference to the block of the second blockchain is recorded. Preferably, the challenge period relates to a probability of finality for, and/or a block depth of, the block of the main chain.

Preferably, the challenge period relates to a block depth of less than ten blocks, less than six blocks, and/or less than four blocks. Preferably, the challenge period relates to a stake of less than ⅔, less than ½, less than ⅓, and/or less than ¼.

Preferably, the first blockchain is arranged to record recovery information relating to the invalidity proof.

Preferably, the recovery information comprises a legitimate block of the blockchain and/or a last legitimate block of the second blockchain.

Preferably, the recovery information comprises an indication of an illegitimate block.

Preferably, the second blockchain is configured to determine a last legitimate block based on the recovery information and/or wherein the second blockchain is configured to begin a fork based on the last legitimate block.

Preferably, the invalidity proof comprises one or more of: evidence of a falsified transaction; evidence of a double-spend; evidence of a falsified block header; evidence of halting of the second blockchain; a reference to a previous transaction of the second blockchain; a fraud proof; and a reference to a previous transaction and/or block of the second blockchain that is recorded on the first blockchain.

Preferably, the method comprises penalising a party related to the invalid transaction and/or invalid block. Preferably, the method comprises penalising a miner, proposer, and/or validator of the invalid transaction and/or invalid block.

Preferably, penalising comprises locking and/or burning an asset relating to the party. Preferably, an asset relating to the first blockchain and/or the second blockchain.

Preferably, penalising comprises prohibiting the party from participating in the proposing, mining, and/or validating of a future block of the first blockchain and/or the second blockchain.

According to an aspect of the present disclosure, there is described a computer-implemented method of proposing a block for addition to a first blockchain, the method comprising: identifying a block of a second blockchain; and including in a proposal block for the first blockchain the identified block of the second blockchain only when: the identified block of the second blockchain extends the second blockchain; and/or the identified block of the second blockchain exceeds a threshold probability of finality; and proposing the proposal block for addition to the first blockchain.

Preferably, the method further comprises outputting the block and/or a transaction of the block.

Preferably, the method further comprises outputting the information and/or a transaction of the information.

According to an aspect of the present disclosure, there is described an apparatus arranged to carry out the aforesaid method.

According to an aspect of the present disclosure, there is described an apparatus arranged to store, access, and/or view the aforesaid blockchain and/or the aforesaid public consensus mechanism.

Preferably, the apparatus comprises a computer implemented device.

Preferably, the apparatus comprises means for presenting information. Preferably, the apparatus comprises a display and/or a speaker.

Preferably, the apparatus comprises a user input. Preferably, the apparatus is arranged to present information relating to a/the blockchain and/or a/the public consensus mechanism in dependence on a user request and/or an event.

Preferably, the apparatus is arranged to communicate with at least one other apparatus. Preferably, the apparatus comprises a node of the first blockchain and/or the second blockchain and/or the first public consensus mechanism and/or the second public consensus mechanism.

Preferably, the apparatus is arranged to communicate with another node of the first and/or second blockchain and/or the first and/or second and/or the public consensus mechanism.

According to an aspect of the present disclosure, there is described a system comprising a plurality of apparatuses arranged to store, access, and/or view the aforesaid blockchain and/or the aforesaid public consensus mechanism of any preceding claim.

Preferably, each of the apparatuses are arranged to communicate with each other. Preferably, each of the apparatuses are arranged to communicate so as to propagate blocks of the first blockchain and/or the second blockchain and/or information on the first and/or second public consensus mechanism to the other apparatuses.
As used herein, configuring a blockchain may comprise adding information to that blockchain (e.g. adding an identifier to a block of the blockchain) and/or altering rules relating to that blockchain (e.g. altering the consensus rules of the blockchain).
Anything described with respect to a blockchain equally applies to a public consensus network, where instead of consideration of a block on the blockchain, the methods/apparatuses may consider information on the public consensus network.
A ‘legitimate’ block and/or fork is typically a block and/or fork that has been added by to the blockchain by honest miners of the blockchain. Equally, a legitimate block and/or fork may be a block and/or fork that does not include a fraudulent or invalid transaction. In contrast an ‘illegitimate’ block and/or fork is typically a block and/or fork in which at least one fraudulent or invalid transaction has been included (e.g. by a malicious actor); this transaction may relate to a double-spend or a transaction from a non-existent address.

The disclosure extends to any novel aspects or features described and/or illustrated herein.

Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

The disclosure extends to methods and/or apparatus substantially as herein described with reference to the accompanying drawings.

Embodiments of the disclosure are described below, by way of example only, with reference to the accompanying drawings.

### BRIEF DESCRIPTION OF THE DRAWINGS

FIG. 1 shows a blockchain on which the methods disclosed herein can be implemented.

FIG. 2 shows a system comprising a main chain and a side chain.

FIG. 3 shows a computer device on which the systems and methods disclosed herein may be implemented.

FIG. 4 shows a network on which the systems and methods disclosed herein may be implemented.

FIG. 5 shows a method for adding a reference to a block of the side chain to the main chain.

FIG. 6a shows an exemplary detailed method for adding a block of a proof of work side chain to a main chain.

FIG. 6b shows an exemplary detailed method for adding a block of a proof of stake side chain to a main chain.

FIG. 7 shows a method of verifying a transaction of the side chain in dependence on a feature of the main chain.

FIG. 8 shows a method of including a transaction relating to the side chain on the main chain based on consensus rules of the side chain.

FIG. 9 shows a method of including recovery information for the side chain on the main chain.

FIG. 10 shows a system that illustrates the method of FIG. 9.

FIG. 11 shows a method of identifying a halting of the side chain.

FIG. 12 shows a system that illustrates the method of FIG. 11.

### DETAILED DESCRIPTION OF THE EMBODIMENTS

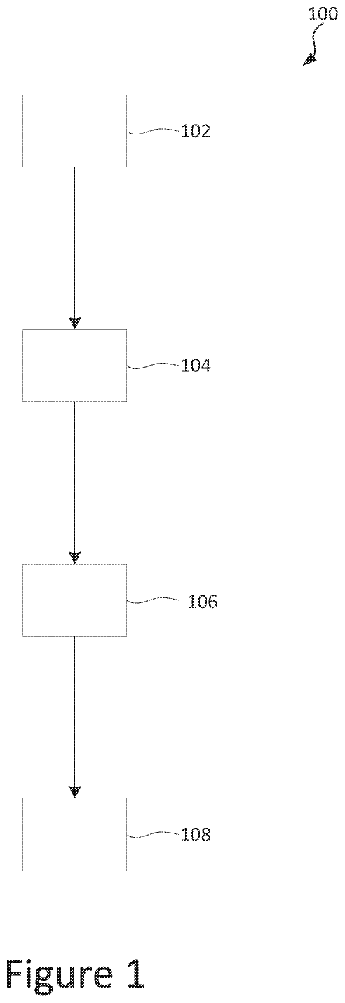

Referring to FIG. 1, there is shown a blockchain 100. The blockchain comprises a first block 102, a second block 104, a third block 106, and a fourth block 108. Each block is dependent on the previous block, so that the fourth block depends on the third block, the third block depends on the second block, and the second block depends on the first block. More generally, the nth block depends on the (n−1)th block and thereby depends on each previous block of the blockchain.

In this way, the blockchain 100 is useable to implement an immutable ledger. Any change to a block of the blockchain alters each subsequent block and so is immediately detectable.

Typically, each block comprises a hash of the previous block; changing any block of the blockchain 100 will alter the hash of that block and therefore alter the hash of each subsequent block (since the subsequent hashes depend on the altered hash).

Typically, each block comprises a body, which contains a record of transactions within the block, and a header, which comprises information relating to the block. For example, the header may comprise: a value relating to the transactions in the body (e.g. a hash relating to a Merkle tree, which Merkle tree is formed of the transactions in the body); a value (e.g. a hash) relating to a previous block and/or a value relating to a proof of work puzzle that has been solved in order to mine the block.

Typically, the blockchain comprises a decentralized blockchain and/or a distributed blockchain. More generally, the methods described herein are applicable to distributed ledgers and/or public consensus networks (PCNs), e.g. networks that require a consensus between a plurality of participant nodes.

Typically, each block comprises information regarding a change of state of one or more variables. In an unspent transaction output (UTXO) blockchain, such as Bitcoin, the block may comprise a series of transactions between two addresses (e.g. between a sender and a recipient). Typically, in UTXO blockchains, the addresses are single use, so that each address is used only a single time as the sender for a transaction. In an account model blockchain, such as Ethereum, the block may comprise a series of state changes for an account (e.g. an account may receive an amount of currency and/or a state of the account may change). The accounts typically persist throughout the blockchain, such that accounts can be referenced repeatedly.

The process for adding blocks to the blockchain 100 varies depending on the implementation. Typically, one or more of the following mechanisms are used:
Proof of Work (PoW). In a proof of work system, a block of recent transactions is formed and is added to the blockchain 100 (‘mined’) when a ‘miner’ finds a solution to a cryptographic problem.
Using Bitcoin as an example, when a miner wishes to add a block to the blockchain 100 the miner takes the hash of the most recent block, adds onto this hash the current block of transactions, and adds onto this combination of the hash and the transaction block a “nonce” (an abbreviation of “number only used once”), which nonce is typically a random number, to create a proposed block. The proposed block is then hashed using a hash function to obtain a new hash. In order for the proposed block to be suitable for addition to the blockchain, the new hash is required to begin with a predetermined number of zeros. This requires the determination of a suitable nonce, and this suitable nonce can only be found through trial and effort.

When a suitable proposed block (e.g. a suitable nonce) is found, the miner who proposed the block is rewarded with an amount of Bitcoin in return for the work done in finding the nonce. The miner is also rewarded with transaction fees, which are offered to the miner by the parties whose transactions are included in the transaction block. These transaction fees are useable to encourage miners to include transactions in a proposed block (and transactions with no offered transaction fee might sit for a considerable amount of time before being included in a proposed block). This method of consensus/mining for Bitcoin is described in more detail in “Satoshi Nakamoto. Bitcoin: A peer-to-peer electronic cash system. http://nakamotoinstitute.org/bitcoin/(2008)”.

Once a suitable nonce has been found, the miner proposes the block for addition to the blockchain. This block is then propagated through validating nodes, which confirm that the transactions in the block are valid (e.g. there are no double spends) and/or that the nonce is a valid solution to the problem.

It will be appreciated that other proof of work mechanisms may be used; for example the cryptographic problem may comprise a verifiable delay function.

Since, generally, the longest blockchain is taken to be the legitimate blockchain, miners are incentivised to build on the longest blockchain and users concur with the transactions that are present in the longest blockchain. This proof of work system thus ensures a certain degree of security, since any malicious actor wishing to alter a block of the blockchain 100 will also need to find a solution to each subsequent block (to provide a new longest blockchain). As an example, if a malicious actor alters a transaction in the (i−2)th block (e.g. to enable a double spend), they will need to find solutions for: the altered (i−2)th block, a new (i−1)th block, a new ith block and then a new (i+1)th block—this can be referred to as determining a new fork of the blockchain. However, while the malicious actor is lengthening this altered fork of the blockchain, the other, honest, miners will be lengthening the original fork. Unless the malicious actor controls a majority of the system computational power/hash rate (the total number of nonce guesses per unit time for all the miners), in the long term the malicious actor will not be able to catch up with the honest miners.

In the short term, there is a chance that a malicious actor with a minority of the system computational power could obtain a longer fork than the honest miners, e.g. through a stroke of fortune the malicious actor could find a correct nonce for a single block (or even a few blocks) before the honest miners. Therefore, in order to give confidence that a transaction is effectively immutable, a recipient may require a transaction to be six or seven blocks deep before confirming a payment. This is often referred to as requiring six or seven ‘confirmations’. At this point it is implausible that a malicious actor with a minority of the computational power could create a chain that catches up to the unaltered chain.

Due to the substantial (and normally prohibitive) cost required for any miner to obtain and sustain a majority of mining power, proof of work systems offer strong security, especially on established blockchains; however, they come with a number of drawbacks.

Firstly, proof of work systems require a significant amount of computing power. With Bitcoin, the amount of work needed to mine a new block is periodically altered so that a new block is mined approximately every 10 minutes. This means that as more miners become involved, the amount of work needed to mine a block increases (while the number of blocks mined per unit time remains the same). A significant, and increasing, amount of computing resource is therefore needed to mine each block (at a high cost, both financially and environmentally).

Conventionally, proof of work systems (such as Bitcoin) have proven difficult to scale (e.g. it has proven difficult to increase the validation throughput of such systems). This difficulty in scaling can decrease the usability of a proof of work system, since it decrease the number of transactions that can be recorded per unit time.

Yet further, a user may desire to obtain a certain number of ‘validations’ before considering a payment as valid—that is, it is desirable for the transaction to be contained in a block that is followed by a number of other blocks, since this makes it more difficult for a malicious actor to alter the block containing the transaction. Since proof of work systems need a certain amount of time to add each block to the blockchain, this is greatly problematic in the modern world where near-instantaneous transactions are often desired.
Proof of Stake (PoS). In a proof of stake system, a miner is selected (typically at random) to propose a new block based on that miner's controlled stake in the blockchain 100. Validators, who confirm that the proposed block comprises valid transactions, are similarly chosen based on their participation in the blockchain. As an example of how this is implemented, where a blockchain issues coins (e.g. Algorand) the proposer/validators can be selected based on the number of coins they hold. Equally, a party may be required to deposit a number of coins to participate in the ballot to be the proposer/validator of a block, where these coins cannot be withdrawn without forfeiting the right to participate in the ballot. Typically, the proposer and each validator receive a reward (e.g. a number of coins) for participating in the proposal/validation of a block.
Exemplary PoS systems are described in Algorand “Silvio Micali. Algorand: the efficient and democratic ledger. CoRR, abs/1607.01341, 2016” and “Vitalik Buterin. Proof of stake: How I learned to love weak subjectivity. https://blog/ethereum.org/2014/11/25/proof-stake-learned-love-weak-subjectivity/, (2014)”.

Such a proof of stake system does not require the solving of any puzzle and does not require the application of large computing resources; partly due to this, the addition of blocks to a proof of stake blockchain can occur much more quickly than for a time-limited proof of work system. With a proof of stake system, security is achieved by the requirement for proposers/validators to hold a significant stake in the blockchain. Given this stake, it is against the self-interest of miners to act in a way that might damage the blockchain and thereby reduce the value of their stake (e.g. by falsifying transactions).

However, one problem that can arise is the issue of centralisation. Since the probability of being selected for participation in the generation of a block is generally dependent on a stake held in the blockchain this can encourage parties to increase their stakes (and therefore their expected reward). This can lead to a few parties holding large stakes, which risks one of these parties attempting to take over the blockchain.

While proof of stake systems typically do not comprise miners in the same way as proof of work systems, for the sake of this description (and for the sake of describing methods that are applicable to both proof of work and proof of stake systems) the party proposing a block in a proof of stake system can be considered to be a miner. More generally, as used herein the term mining refers to the general process of proposing a block for addition to a blockchain as well as the specific process used for proof of work systems.
Proof of Authority (PoA): a proof of authority system is based on authorised users, where only certain users are able to add blocks to the blockchain 100 and/or validate blocks of the blockchain. As an example, the CEO of a company may be the only party authorised to add blocks to a blockchain provided by that company. This method enables the rapid addition of blocks, but requires power to rest in a limited number of parties. In the example given, the CEO would have the power to alter the blockchain on a whim—this has clear drawbacks for, say, a blockchain being used to track monetary transactions. Each party making a transaction would need to trust the CEO to act honestly (and to not make a mistake).

More generally, a proof of authority system requires each user to trust the authorised parties, which is undesirable in many circumstances.

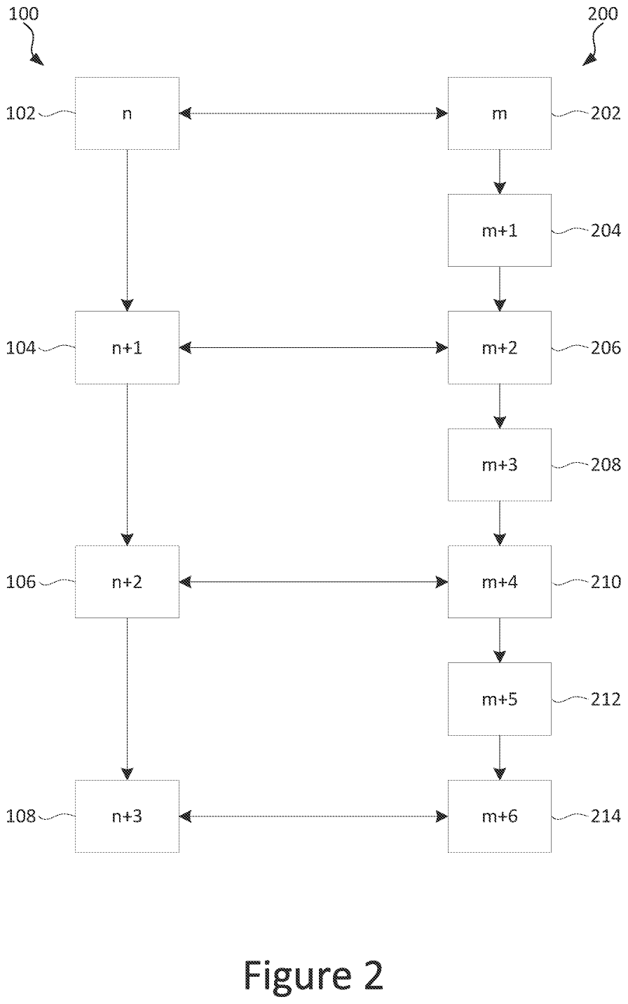

Referring to FIG. 2, one system that has been proposed—in particular to overcome the drawbacks of proof of work systems—is a system comprising a ‘main chain’ 100 and one or more ‘side chains’ 200. The side chain 200 comprises a blockchain which is used in conjunction with the main chain blockchain. As an example, Bitcoin and/or Bitcoin SV, could be used as the main chain, with a different blockchain (such as Ethereum or Algorand) used as the side chain.

To enable the side chain 200 to benefit from the main chain 100, information relating to the side chain, e.g. transactions that are recorded on the side chain, is also recorded on the main chain. In some implementations, the recording may comprise copying each side chain transaction into a block of the main chain and/or copying the entire state of the side chain at a given time (e.g. the amount of a currency held by each party in the side chain) into the main chain. Alternatively, this recording may comprise recording an identifier relating to the state of the side chain at a given time. As an example (and as shown in FIG. 2), a hash relating to the mth block 202 of the side chain may be recorded in the nth block 102 of the main chain. At a later date, a party using the side chain is able to view the main chain to ensure that the mth block of the side chain has not been altered (by comparing a hash of the mth block of a longest fork of the side chain to the hash in the nth block of the main chain).

Similarly, continuing with the example of FIG. 2 the (n+1)th block 104 of the main chain 100 may contain a reference to (e.g. a hash of) the (m+2)th block 206 of the side chain 200; the (n+2)th block 106 of the main chain may contain a reference to the (m+4)th block 210 of the side chain; and the (n+3)th block 108 of the main chain may contain a reference to the (m+6)th block 214 of the side chain. The (n+1)th block of the main chain may also contain a reference to the (m+1)th block 204 of the side chain (and so on).

Due to this referencing of the side chain 200 in the main chain 100, a side chain can be used that is less secure than, but has a higher block frequency than, the main chain, where the security of the side chain is increased by the use of the main chain. In the example of FIG. 2, the block frequency of the side chain is twice that of the main chain; assuming that each chain has the same number of transactions per block, this enables the side chain to record twice as many transactions in a given time period. However, this higher block frequency may lead to the side chain being seen as less secure (e.g. if it is a result of the side chain being a proof of stake chain or a chain with a simple proof of work problem). By recording the side chain—or a hash relating to a block of the side chain—on the main chain an additional layer of security can be added. Once a block of the side chain is recorded on the main chain, the alteration of any previous block of the side chain can be immediately identified by reviewing the main chain.

Where the side chain 200 is used, a user is typically able to perform transactions between the main chain 100 and the side chain, with the transactions leading to the locking of a section of the main chain and/or the side chain. This can be described straightforwardly where the transaction relates to an amount of an asset, using the prior example of Bitcoin and Ethereum. An amount of Bitcoin can be ‘transferred’ from the main chain to the side chain, where the transfer is recorded on the Bitcoin blockchain (and results in this amount of Bitcoin being ‘locked’). A corresponding amount of Ether is then unlocked (or generated) on the side chain and a user is able to perform transactions using this Ether (with these transactions being recorded on the Ethereum blockchain and/or the Bitcoin blockchain). In some implementations, the owners of the Ether can then transfer the Ether back to Bitcoin; this results in the previously locked Bitcoin being ‘unlocked’ and transferred to the new owner. The ‘locking’ of asset may comprise the asset being transferred to an address that is associated with a smart contract and/or that is controlled by a trusted third party. This ensures that this locked amount cannot be transferred or unlocked without certain conditions being met (e.g. the locking of a corresponding amount of currency on the other chain).

The transfer of coins from the main chain 100 to the side chain 200 and from the side chain to the main chain is typically called a ‘two-way peg’. Certain methods for implementing a two-way peg (and indeed other types of peg as well as sidechains more generally) have been previously considered. Such methods are examined in depth in “Adam Back et al. Enabling blockchain innovations with pegged sidechains. https://blockstream.com/sidechains.pdf, (2014)” And “PS sidechains: Ben Edgington. State of Ethereum protocol #2: The beacon chain. https://media.consensys.net/state-of-ethereum-protocol-2-the-beacon-chain-c6b6a9a69129 (2018)”.

Typically, in the event that the side chain 200 is compromised, the main chain 100 can remain secure (e.g. in the event the Ethereum side chain is compromised, only the Bitcoin that had been ‘locked’ would be affected).

As mentioned beforehand, this side chain arrangement enables the utilisation of advantages of the main chain 100 (e.g. security, or extant miners), while enabling, via the side chain 200, the use of other blockchain technologies that might have their own advantages (e.g. high validation throughput). These advantages can be particularly pronounced where the main chain and the side chain use different anti-sybil or consensus mechanisms. In particular, a proof of work system can be used by the main chain to ensure security while a proof of stake system is used by the side chain to enable the rapid validation of transactions.

In particular, an arrangement is disclosed wherein the side chain 200 is “nested” within the main chain 100; that is, where each transaction and/or each block of the side chain (and/or all of the information stored on the side chain) is recorded on the main chain. The side chain may be stored on the main chain with reference to an identifier, such as an account and/or a side chain smart contract of the main chain.

While the description refers to the main chain 100 and the side chain 200, it will be appreciated that more generally the methods herein are applicable to a first blockchain and a second blockchain (and, optionally, one or more further blockchains). Yet more generally, the methods herein are applicable to a first public consensus network and a second public consensus network (and, optionally, one or more further public consensus network).

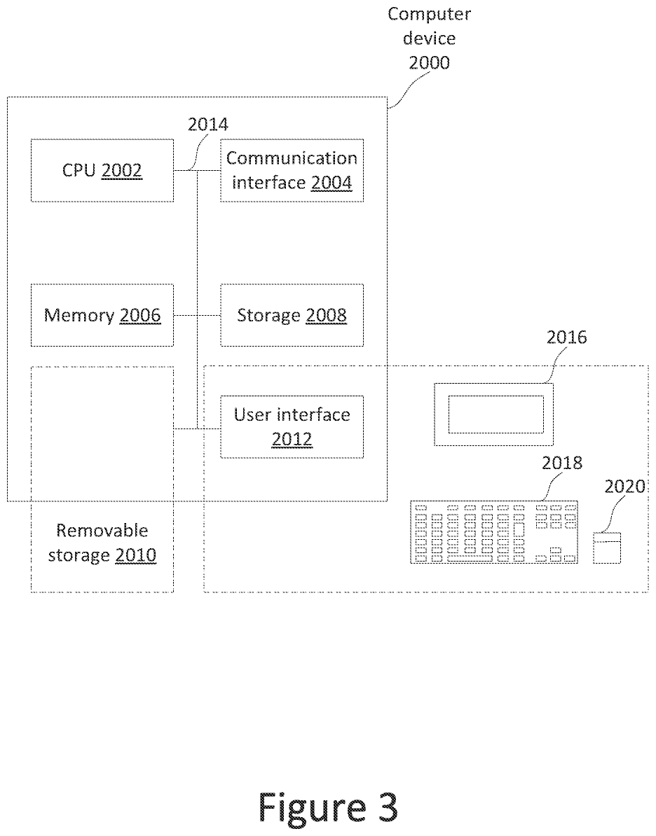

Referring to FIG. 3, the main chain 100 and the side chain 200 are each configured, added to, and/or viewed using a computer device 2000. In particular, each node that validates transactions is implemented using such a computer device. Similarly, each mining or proposing node, which propose blocks for addition to the main chain or the side chain, is implemented using a computer device 2000. Furthermore, each viewer of the main chain or the side chain accesses the main chain and the side chain using a computer device. Nodes, miners, and/or viewers may be implemented on the same computer device.

Each computer device 2000 typically comprises a processor in the form of a CPU 2002, a communication interface 2004, a memory 2006, storage 2008, removable storage 2010 and a user interface 2012 coupled to one another by a bus 2014. The user interface comprises a display 2016 and an input/output device, which in this embodiment is a keyboard 2018 and a mouse 2020.

The CPU 2002 executes instructions, including instructions stored in the memory 2006, the storage 2008, and/or the removable storage 2010.

The communication interface 2004 is typically an Ethernet network adaptor coupling the bus 2014 to an Ethernet socket. The Ethernet socket is coupled to a network, such as the Internet. The communication interface facilitates communication between the nodes of the main chain 100 or the side chain 200 (which are referred to more generally as the blockchains 100, 200) and enables each node to validate and propagate transactions and each miner to propose blocks to the network. It will be appreciated that any other communication medium may be used by the communication interface, such as area networks, infrared communication, and Bluetooth®.

The memory 2006 stores instructions and other information for use by the CPU 2002. The memory is the main memory of the computer device 2000. It usually comprises both Random Access Memory (RAM) and Read Only Memory (ROM).

The storage 2008 provides mass storage for the computer device 2000. In different implementations, the storage is an integral storage device in the form of a hard disk device, a flash memory or some other similar solid state memory device, or an array of such devices. To run a full node of the main chain 100 and/or side chain 200, that is a node which contains the entirety of the blockchain, the storage is typically required to have a large capacity. The computer device may also be capable of running a partial, or light, node, where the storage 2008 stores only a portion of the blockchain.

The removable storage 2010 provides auxiliary storage for the computer device 2000. In different implementations, the removable storage is a storage medium for a removable storage device, such as an optical disk, for example a Digital Versatile Disk (DVD), a portable flash drive or some other similar portable solid state memory device, or an array of such devices. In other embodiments, the removable storage is remote from the computer device, and comprises a network storage device or a cloud-based storage device.

Each node, miner, and viewer uses a computer device 2000 to implement aspects of the methods and systems as described herein. Typically, the computer device used by each party is specialised; for example miners proposing blocks to be added to the main chain 100 and/or side chain 200 may use a computer device that comprises an application specific integrated circuit (ASIC), a field programmable gate array (FPGA), or a graphics processing unit (GPU). In some embodiments, the computer device comprises numerous racks of ASICs, FPGAs, or GPUs with a single user interface, where the computer device may be wholly specialised for mining blockchains.

Typically, the computer device 2000 of each node is arranged to receive transactions, to validate these transactions, and then to propagate the validated transactions throughout a network. The computer devices of the miners (which miners may also be nodes) are then able to collate a number of validated transactions into a block; this block can then be proposed for addition to a blockchain. The addition of the proposed block to the blockchain 10 may rely on, for example, providing a proof-of-work (as described in e.g. Bitcoin: “Bitcoin: A Peer-to-Peer Electronic Cash System. Nakamoto, S. (2008) https://bitcoin.org/bitcoin.pdf”) or providing a proof-of-stake (as described in e.g. Algorand: “ALOGRAND Chen, J. (2017) https://algorandcom.cdn.prismic.io/algorandcom%2Fece77f38-75b3-44de-bc7f-805f0e53a8d9_theoretical.pdf”).

In an exemplary usage of the main chain 100 and/or side chain 200, a node combines a number of transactions into a block, and then proposes this block for addition to the blockchain. Other nodes validate and propagate this block to the users of the blockchain. Once the block is added to the blockchain, a transaction included in this block can be presented to a user, where the information contained in the transaction can be used for a variety of purposes (e.g. to improve the design of machines, to ensure adherence to government regulations, or to identify risky or endangering behaviour). It will be appreciated that while the term transaction is used throughout—and is commonly used in reference to blockchains—each blockchain is more generally capable of the (preferably immutable) storage of information. Therefore, while transactions may relate to a financial transaction, more generally the transactions in a block may relate to the storage of any (technical and/or non-technical) information.

A computer program product is provided that includes instructions for carrying out aspects of the method(s) described below. The computer program product is stored, at different stages, in any one of the memory 2006, storage device 2008 and removable storage 2010. The storage of the computer program product is non-transitory, except when instructions included in the computer program product are being executed by the CPU 2002, in which case the instructions are sometimes stored temporarily in the CPU or memory. It should also be noted that the removable storage is removable from the computer device 2000, such that the computer program product may be held separately from the computer device from time to time. Different computer program products, or different aspects of a single overall computer program product, are present on the computer devices used by any given miner and/or user of the main chain 100 and/or the side chain 200.

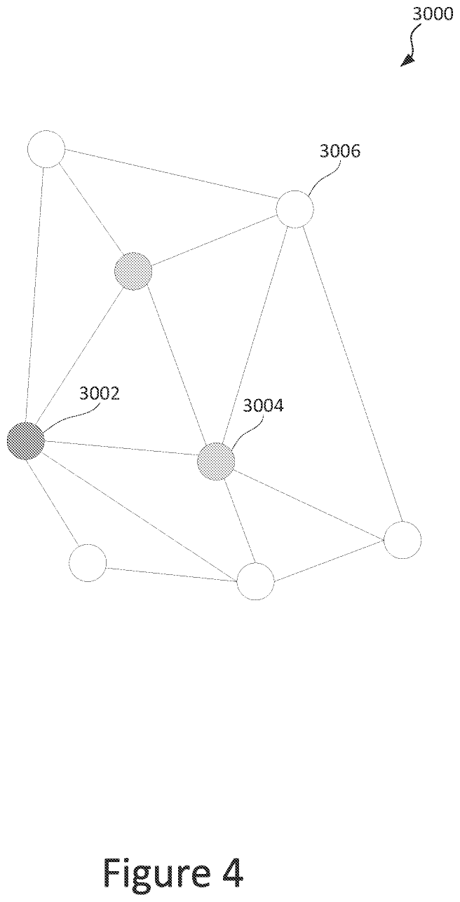

Referring to FIG. 4, the methods disclosed herein are typically implemented in relation to a network 3000, which network is typically arranged to view, add to, and/or configure a blockchain (e.g. the blockchain 100 of FIG. 1).

The network typically relates to one of the main chain 100 and the side chain 200, where there are typically different networks for each of the main chain and the side chain. There may be some overlap between these networks, where one or more nodes may be a node of both the main chain and the side chain.

The network 3000 comprises one or more nodes 3002, 3004, 3006, which nodes are arranged to communicate (directly or indirectly) to propagate information. The nodes typically comprise computer devices.

The network 3000 may have one or more of the following properties:
Be a centralised network, in which communications are propagated by a single node (or a group of nodes).
Be a decentralised network, in which nodes of the network are arranged to communicate with each other directly (e.g. not via a central authority).
Be a distributed network, where records relating to the network are stored on a plurality of the nodes.

This prevents a single node from editing the record (since this editing would be noticed by the other nodes).

Typically, the disclosures herein are implemented on a decentralised, and/or distributed, network.

The nodes 3002, 3004, 3006 are arranged to communicate with each other so as to propagate information throughout the network. This information typically comprises blocks of the blockchain. The nodes may be configured differently and/or arranged to provide different services. For example, the network may comprise:
A mining node 3002, which mining node is arranged to propose blocks for addition to the blockchain.
A validating node 3004, which validating node is arranged to validate the blocks proposed by the miner (e.g. confirm that the blocks are correctly formatted and/or comprise valid transactions). A validating node may run a ‘full’ node and comprise a record of the entire blockchain. Such a full validating node may validate a block of the blockchain based on previous blocks of the blockchain (e.g. to ensure that a party transferring an asset does indeed hold that asset). A validating node may run a ‘light’ or ‘partial’ node and comprise a record of only a part of the blockchain. Such a partial validating node may validate a block based on the transactions in that block and/or block headers from previous blocks (e.g. to ensure that a hash of the transactions of block corresponds to a value in the header of the block).
A propagating node 3006, which propagating node is arranged to receive information from other nodes and then forward this information to ensure that it reaches other nodes in the network.

More generally, one or more nodes of the network 3000 may be arranged to participate in the addition and/or validation of blocks on the blockchain and/or to propagate blocks throughout the network.

It will be appreciated that nodes may provide a plurality of services; for example, mining nodes typically also perform validation and propagation.

The methods disclosed herein are typically carried out by one or more of the nodes of the network 3000. The network may be a network relating to the main chain 100 and/or a network relating to the side chain 200, where there is typically a main chain network that is separate from a side chain network. The discoed methods may then be carried out by a node of the relevant network (e.g. addition of a block to the main chain is typically performed by a node of the main chain). Typically, the nodes of the main chain are arranged to communicate with other nodes of the main chain and nodes of the side chain are arranged to communicate with other nodes of the side chain. In some embodiments, nodes of the main chain and the side chain are arranged to communicate.

Typically, nodes and/or parties are implemented on the computer device 2000. The methods described herein may then be performed (e.g. by a node) using a computer device. The methods typically relate to an interaction between computer devices, where information may be transmitted between the computer devices of a plurality of nodes. In particular, information determined at a first computer device (e.g. a first node) may be transmitted to a second computer device (e.g. a second node) and output on the further computer device. Where the information is part of a block of the blockchain, the second computer device may be able to determine that the information is recorded in an immutable manner. The information, and the knowledge that it is recorded in an immutable manner, can affect the actions of the second node and/or the party controlling the second node.

### Simple Block Verification

So that the validation load of the main chain 100 is not excessively increased by the presence of the side chain, it is desirable to use a computationally simple method of adding information relating to the side chain 200 to the main chain. In particular, it is desirable to use a computationally simple method of verifying that blocks of the side chain are suitable for inclusion in the main chain.

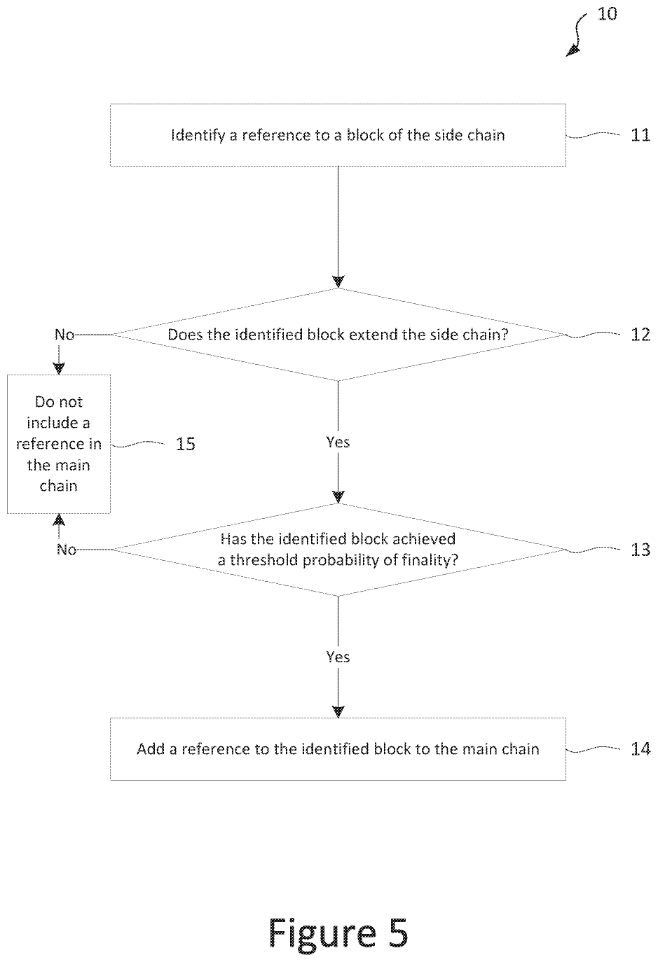

Referring to FIGS. 5, there is described a method 10 for including a reference to a block of the side chain 200 in a block of the main chain 100. This method is typically performed by the computer device 2000 of a validating node before a transaction/record is validated for addition to the main chain 100.

In a first step 11, a reference to a block of the side chain 200 is identified. In various embodiments, the reference comprises one or more of: a block of the side chain; a plurality of blocks of the side chain; a transaction within a block of the side chain; and a hash relating to a block of the side chain. Typically, the reference comprises a header of one or more blocks of the side chain and/or a hash of such a header. The reference may relate to a recent, or most recent, block of the side chain 200 and/or may relate to one or more blocks that have been added to the side chain since the addition of a prior reference to the main chain 100. Considering the example of FIG. 2, since two side chain blocks are generated for each main chain block, the reference may relate to two blocks (so that each block of the side chain is referenced by the main chain) or the reference may relate to only the most recent block of the side chain (depending on the side chain, the most recent block may store all relevant information).

In some embodiments, the method is arranged to ensure that there is a reference to each block of the side chain 200 on the main chain 100. This may comprise the node performing the method identifying a reference to a plurality of blocks of the side chain, e.g. by identifying a plurality of sub-references to individual blocks.

Equally, the reference may comprise a sum of states and/or a result of transactions for a plurality of blocks of the side chain. For example, where a transfer from A->B occurs in a first block and a transaction from B C occurs in a second block, the reference may simply identify a transfer from A->C. The node performing the method 10 of FIG. 5 may be arranged to identify an effect and/or a transition of a plurality of blocks and the reference may depend on this effect or transition of a plurality of blocks.

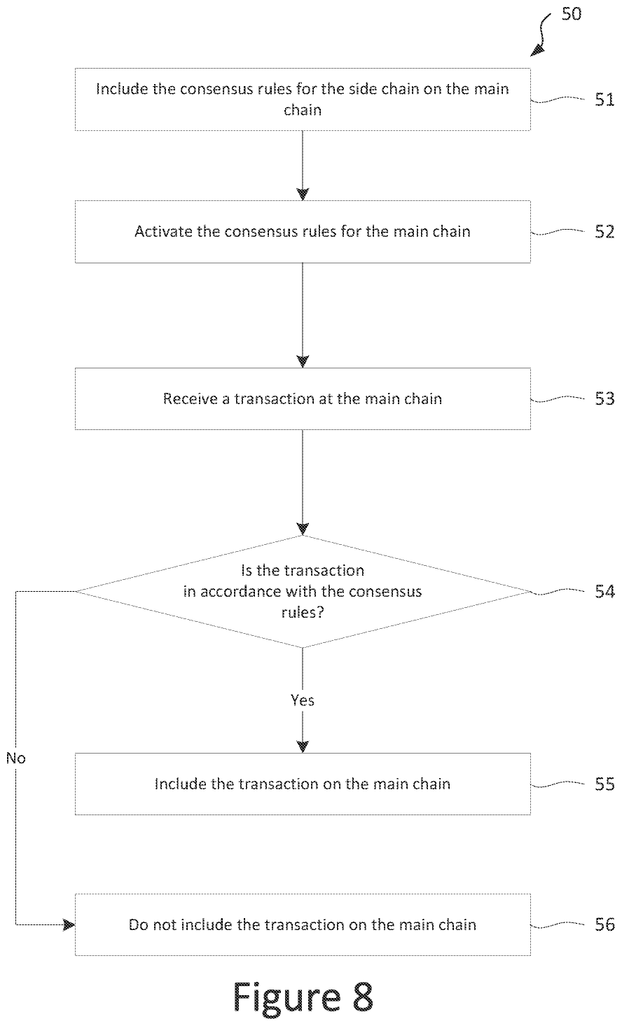

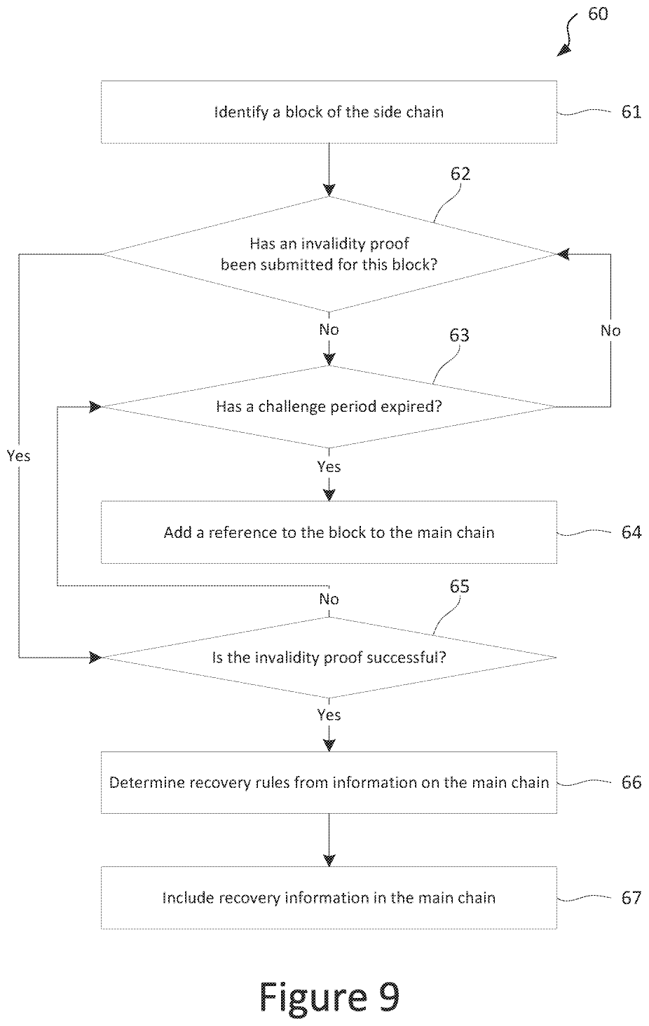

In some embodiments, the reference is arranged such that a block of the side chain 200 and/or the entirety of the side chain can be recovered from the reference. As an example, the reference may include: a commit of a certain block of the side chain, the entirety of a certain block of the side chain, each transaction contained in a certain block of the side chain, and/or the states of each account defined by the side chain at a given time. If the side chain is compromised (e.g. by a malicious actor), the side chain can then be recovered based on this stored record. Typically, the main chain 100 records at least a reference to a block of a side chain, this reference can be used to determine a known legitimate block of the side chain so that if the side chain is compromised this known legitimate block is useable as a recovery point. A more detailed method of recovering the side chain is described below with reference to FIGS. 8 and 9.

Typically, the reference relates to each block that has been added to the side chain 200 since the addition of the last block of the main chain 100. This ensures that a full record of the side chain is stored on the main chain. Typically, the reference comprises a record of each state transition and/or transaction that is contained in one or more blocks of the side chain.

Typically, the reference includes any state transaction functions included in a block of the side chain 200. In particular, the block of the side chain may comprise one or more functions that govern transactions (e.g. to determine which party receives an amount of Ether); typically, such functions are included in the main chain 100. In some embodiments, the main chain and/or the side chain are configured such that the state transition functions are interpretable by any reader of the main chain. This prevents users from including encrypted and/or hidden state transition functions, which can prevent users of the side chain and/or main chain from identifying fraud.

Typically, only state transaction functions that relate to consensus rules (and/or validity rules) are required to be interpretable by any reader of the main chain 100. This enables each node of the main chain to determine that each block of the side chain 200 is valid. In such embodiments, information stored in certain transactions of the side chain (which does not affect the validity of a block) may still be stored in an obscured or encrypted form.

In a second step 12, it is determined whether the identified block extends the side chain 200. Since the longest fork of the side chain is conventionally taken as the legitimate side chain, this step ensures that the identified block is not an attempt by a malicious actor to record a different fork of the side chain. For example, if the longest extant side chain is m blocks long, the second step comprises ensuring that the identified block is an (m+1)th block and not, for example, an alternate (m−1)th block. More generally, the second step comprises determining that the identified block is an addition to a legitimate fork of the side chain, where the conditions for legitimacy may depend on the implementation. As an example, a longest fork may be deemed illegitimate if a signatory of a previous block is found to be untrustworthy. The conditions for legitimacy may be recorded on the main chain 100 (so that they cannot be altered). In some embodiments, the conditions comprise, and/or consist of, a requirement that the fork being added to is the longest extant fork.

In order to determine whether the identified block extends the side chain (or meets other legitimacy conditions), a node performing the method 10 may identify in the main chain 100 a previous reference to the side chain 200. Alternatively, or in addition, the node may consider a publicly available record of the side chain.

Typically, the last block of the side chain 200 that has been included in the main chain 100 is determined. It is then determined whether the identified block is a descendent of this included block. This determination may comprise comparing a hash of the identified block to a hash of the included block. In particular, a hash stored in a header of the identified block may be compared to a hash stored in a header of the included block.

In the example of FIG. 2, the sidechain has a block frequency that is twice that of the main chain; in this example, each block of the main chain may comprise a reference to the side chain. In other examples, the side chain may have a smaller block frequency than the main chain and/or an irregular block frequency.

The previous reference may then be identified in a previous block of the main chain that is not the immediately previous block.

In some embodiments, the second step 12 comprises consideration of the side chain 200 at the time of the addition of a block to the main chain 100. For example, the node performing the method of FIG. 5 may evaluate a publicly available version of the side chain in order to determine whether the most recent reference to the side chain included in the main chain refers to a recent, or most recent, block of the side chain.

In a third step 13, it is determined whether the identified block has achieved a threshold probability of finality. Achieving a threshold probability of finality relates to the identified block having a small and/or negligible chance of being orphaned (not included in the side chain 200). This ensures that the record stored by the main chain 100 does not contain any incorrect blocks of the side chain (e.g. blocks from a fork of the side chain that is later surpassed).

Typically, the accepted version of a blockchain is the longest chain. In a very basic example of where this can cause an issue: where two blocks are added to the blockchain at similar times (e.g. because two miners have independently and near-simultaneously solved a proof of work puzzle) there can be some uncertainty over which of these blocks will form the basis for the eventual longest fork (and the eventual legitimate blockchain). Such a problem is generally resolved when a further block is added to one of the two possible blockchains, this blockchain then becomes the accepted version. The last block of the other blockchain is then orphaned and the transactions recorded in the orphaned block are not included in the legitimate fork. Typically, it is desired not to include orphaned blocks in the main chain 100.

For a proof of work system, as a general rule the older that a block is the less chance there is of this block being orphaned. The most recent, ith, block has a relatively high chance of being orphaned. The prior, (i−1)th, block has a lower chance of being orphaned, the next prior, (i−2)th block has an even lower chance, and so on. Therefore, many users of proof of work blockchains require a certain number of confirmations (the inclusion of a transaction in a certain number of blocks) to acknowledge a transaction has occurred.

For other consensus mechanisms the probability of a block being orphaned may depend on other factors, e.g. the number of stakeholders of a proof of stake system who have validated a block.

The third step 13 involves a computer device 2000 implementing the method 10 determining that the chance of the identified block being orphaned is low enough that the probability that the block has achieved finality is high. In various embodiments, the required probability of finality is greater than 90%, greater than 95%, greater than 99%, and/or greater than 99.9%. For Bitcoin, a block with six confirmations (or a block depth of six) has a greater than 99.9% probability of finality.

In a fourth step 14, the reference is added to the main chain 100. Typically, this comprises the reference being included in a block of the main chain. The mechanism of the inclusion of the reference in the main chain typically comprises the reference being included in a block of transactions that is being proposed for addition to the main chain.

In a rejection step 15, if the identified block does not extend the side chain 200 or has not reached a threshold probability of finality, the reference to the identified block is not included in the main chain 100.

In some embodiments, the main chain 100 comprises a section and/or an identifier that relates to the side chain 200. This section/identifier can then be sought out by a user wishing to view information about the side chain. In some embodiments, the main chain comprises a smart contract that relates to the side chain (a ‘side chain smart contract’). Such a smart contract enables the storage of information relating to the side chain as well as: the recording of rules relating to the smart contract (e.g. consensus rules); the defining of functions that may be performed using the side chain; and/or the storage of rules that affect the operation of the side chain. In particular, the side chain smart contract (or more generally the information stored on the main chain) may comprise consensus information and/or legitimacy information that indicates which fork of the side chain is legitimate and/or indicates the requirements for adding a block to the side chain. The side chain (and/or nodes of the side chain) may be configured to identify the consensus information and/or legitimacy information from the main chain so that the side chain can be controlled using information stored on the main chain (which stored information is effectively immutable).

In some embodiments, the adding of the reference comprises the updating of one or more accounts on the main chain 100, the accounts being associated with the side chain 200. For example, a side chain smart contract recorded on the main chain may references accounts on the side chain—the adding of the reference may comprise updating these accounts on the side chain smart contract based on transactions recorded in the block of the side chain. In this way, the smart chain side contract on the main chain stores a record of the state of each account on the side chain. The block of the side chain may comprise state transitions, where the accounts stored on the side chain smart contract are then moved between different states based on the transitions in the block of the side chain.

It will be appreciated that the determinations of the second step 12 and the third step 13 may be used in isolation or in combination. In other words, in some embodiments the addition of the reference to the main chain 100 is dependent only on the second step and in some embodiments the addition of the reference to main chain is dependent only on the third step. In some embodiments, both the second step and the third step are skipped; however, this risks the addition of falsified or orphaned blocks to the main chain.

In some embodiments, the computer device 2000 carrying out the method 10 of FIG. 5 performs verification and/or validation of the transactions within the identified block of the side chain 200. However, such verification/validation can require substantial computing power, so typically the transactions of the side chain are not verified/validated at this stage. In such embodiments, miners of the main chain 100 may be partially reliant on verification/validation carried out by miners of the side chain 200. In other words, the verification/validation load can be largely borne by miners of the side chain. This is beneficial, for example, where the main chain is Bitcoin. If additional miners join the bitcoin mining pool, the cryptographic problem to be solved increases in difficulty so as to maintain a 10 minute period between the addition of blocks. Therefore, more miners joining does not increase the validation throughput. However, if these miners instead mine a side chain, they may will be able to contribute to the addition of transactions to the side chain at a higher throughput. These side chain transactions can then be included in the main chain through the method 10 of FIG. 5. Since the verification/validation of the transactions is carried out on the side chain, the load on the miners of the main chain is reduced. In this way the effective validation throughput of the main chain can be increased without decreasing security or incentivising centralisation.

In some embodiments, the nodes of the main chain 100 (e.g. the parties proposing blocks of the main chain) perform the same verification on the identified block of the side chain 200 as light nodes and/or partial nodes of the side chain 200. In particular, the light nodes of the main chain may assume that previous blocks of the side chain are legitimate and verify the identified block in isolation (or based on a header of a previous block of the side chain). The light nodes may receive a header and/or a hash of a previous block from full nodes and then perform verification/validation of the identified block based on the header and the current block. For example, the light node can consider the hash of a previous block and the hash of the transactions in the identified block to ensure that the hash of the identified block is valid (e.g. is related to a combination of the hash of the previous block and a hash of the transactions). The nodes of the main chain may perform similar verification on the block of the main chain and/or the block of the side chain.

The method 10 of FIG. 5 helps to address the problems of centralisation. Regarding centralisation, there is a potential issue encountered if the block size of the main chain 100 is increased; while this enables the storage of more transactions per block, it also increases the computing requirements for any party validating that block. This can discourage smaller parties from validating blocks, which leads to in validation being performed by a small number of large parties. However, by moving some of the validation load to the side chain 200, smaller parties can continue to contribute to validation on the main chain by performing validation for side chain blocks (which validation need not be repeated by main chain validators) and also by performing validation for main chain blocks (since the validation load is partially borne by side chain miners).

While a computer device 2000 carrying out the method 10 of FIG. 5 may carry out steps to verify the transactions in the block of the side chain, in a simple implementation that requires only a small amount of computing power, the device carrying out the method 10 of FIG. 5 and adding an (n+1)th block to the main chain 100 performs at least the steps of:
a) Verifying that an identified block of the side chain 200 represents an extension of the side chain 200 stored in the last block of the main chain 100 (e.g. the nth block).
b) Verifying that the identified block of the side chain 200 has achieved a threshold probability of finality.
c) Include a reference to the identified block of the side chain 200 in the new block of the main chain 100 (e.g. the (n+1)th block).

As aforementioned, the computer device 2000 may carry out only a single step of steps a and b of the above implementation.

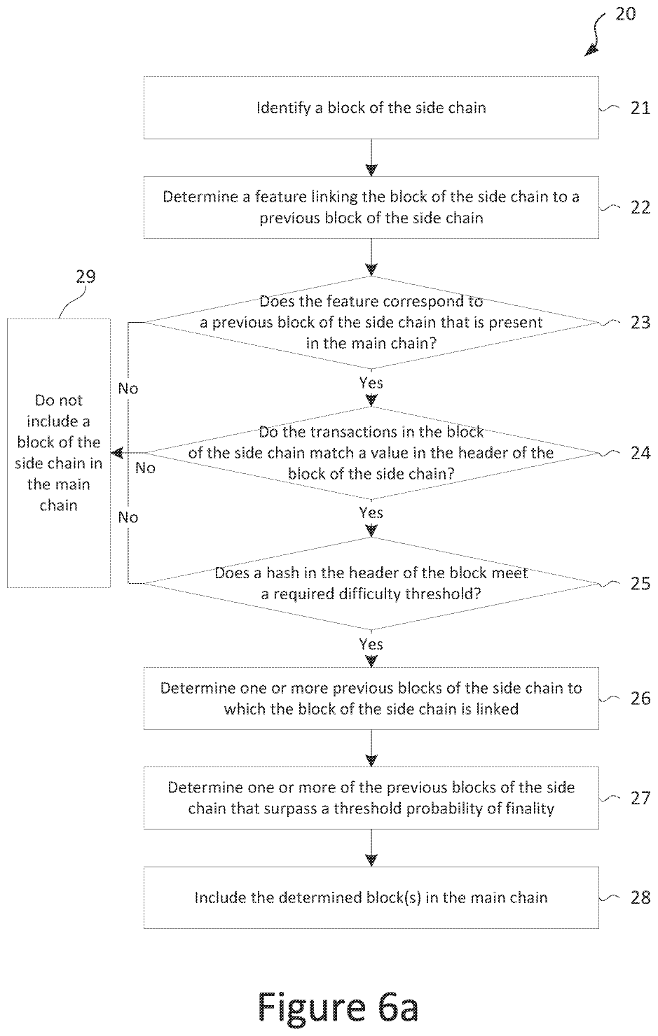

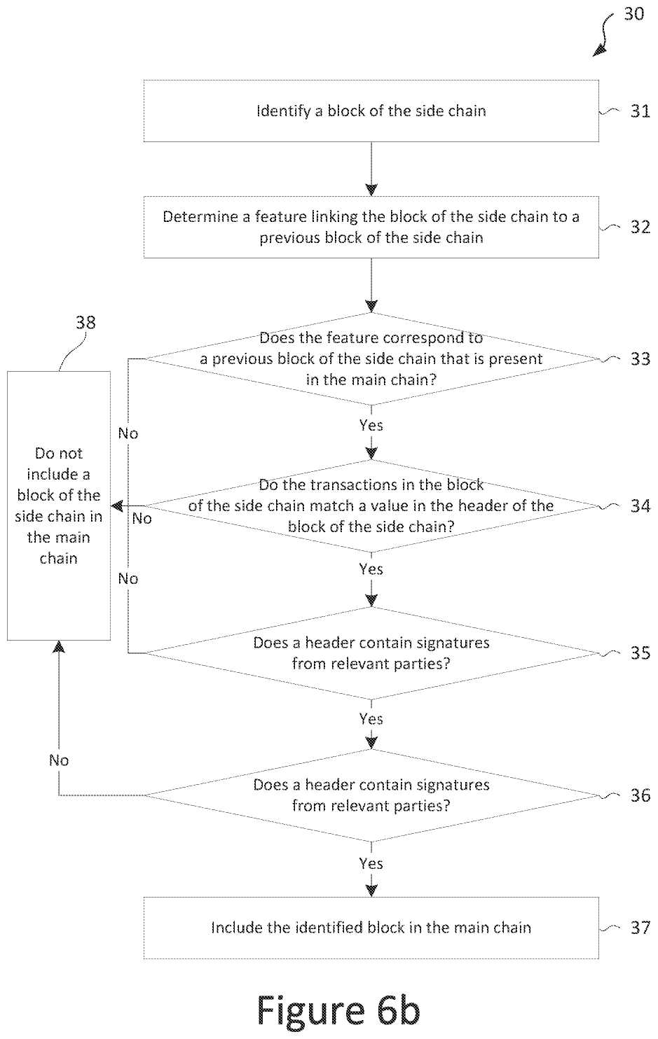

Referring to FIG. 6a, there is described an exemplary detailed method 20 of including a reference to a block of the side chain 200 in a block of the main chain 100 where the side chain uses a proof of work system. It will be appreciated that the aspects of this more detailed exemplary method may be used in any combination and in differing implementations only a subset of the following steps are performed.

In a first step 21, a block of the side chain 200 is identified. This block is typically a block that has been proposed for inclusion in a block of the main chain 100, where a miner may then validate the block for inclusion. In this example, the block comprises a whole block of the side chain, which comprises a block header and a number of transactions.

In a second step 22, a feature linking the identified block of the side chain 200 to a previous block of the side chain that is included on the main chain 100 is determined. Typically, this feature is included in a header of the identified block. The feature may comprise a hash of the identified block of the side chain (e.g. a hash formed of, or dependent on, the previous blocks of the side chain) or a sequence number.

In a third step 23, it is determined whether the feature corresponds to a previous block of the side chain 200 that is present in the main chain 100. This typically comprises comparing a hash of the identified block to a hash of the previous block in order to determine that the identified block is a descendent of the previous block (e.g. where the identified block is the mth block, it is determined whether the main chain references any block before the mth block, e.g. the (m−1)th block, the (m−2)th block . . . the 2nd block, or the 1st block of the side chain).

In some embodiments, the third step 23 comprises determining whether the feature links the identified block to an immediate descendent of a previous block stored on the main chain 100 (e.g. where the identified block is the mth block, it is determined whether the main chain references the (m−1)th block). This ensures that each and every block of the side chain 200 is eventually stored on the main chain (e.g. no blocks are skipped).

Due to the probability of finality requirement described with reference to the third step 13 of the method 10 of FIGS. 5, the most recent block of the side chain may not be the block that is added to the main chain. As an example, and with reference to FIG. 2, where a block depth of six is required for finality the (n+3)th block 108 of the main chain may reference/record the mth block 202 of the side chain.

The third step may comprise determining that recording the identified block on the main chain will extend the record of the side chain that is already stored on the main chain. Further, the third step may comprise determining that the identified block is the immediate descendent of the last block of the side chain that has been recorded on the main chain.

In some embodiments, the third step 23 comprises determining whether the feature links the identified block to any previous block of the side chain that is referenced by/recorded on the main chain 100, where this referenced stored block may not be the immediately preceding block (e.g. where the identified block is the nth block, the stored block may be the 1^{st}, 2^{nd}, . . . (n−2)th, or (n−1)th block). Such an implementation is useful where blocks of the side chain 200 are recorded on the main chain irregularly and/or intermittently.

Where a plurality of blocks of the side chain 200 are identified, the feature may link the earliest identified block to a previous block of the side chain that is present in the main chain 100. For example, both the (m−1)th and mth block of the sidechain may be identified in the first step 21 and the third step 23 may comprise determining whether the (m−2)th block is present in the main chain and/or whether an earlier block is present in the main chain.

Typically, the feature is compared to a most recent block of the side chain 200 that is stored on the main chain 100 and/or a block of the side chain that is stored in the most recent block of the main chain.

Typically, the third step 23 further comprises checking that the identified block is a later block of the side chain 200 than the previous block of the side chain that is stored on the main chain 100.

If the feature does correspond to a previous block of the side chain 200 that is present in the main chain 100, then in a fourth step 24, it is determined whether the transactions in the identified block correspond to a value in the header of that block. Typically, this comprises determining whether a value of a Merkle tree formed from the transactions in the identified block matches the value in the header. This step is a part of checking the validity of the identified block of the side chain.

If the transactions in the identified block match the value in the header, then in a fifth step 25, it is determined whether a hash in the header of the identified block meets a required difficulty threshold. This ensures that the identified block is a valid block. Using the example of Bitcoin, as has been described above adding a block to the Bitcoin blockchain requires the solving of a cryptographic puzzle. The solving of this puzzle is demonstrated by the obtaining of a hash with a certain number of leading zeros. This hash (and the solution) can then be provided to demonstrate that the solution has been found.

More generally, the fourth step 24 and the fifth step 25 comprise checking that the identified block of the side chain 200 is a valid block of that side chain. Other methods of checking may be used as well or alternatively. For example, a version of the side chain held by a trusted node (and/or third party) may be checked to determine whether the block being added to the main chain is present in the version held by the node.

If any of the checks of the third step 23, the fourth step 24, or the fifth step 25 are failed, then in a rejection step 29, the block of the side chain 200 is not included in the main chain 100.

If the required difficulty threshold is met, in a sixth step 26 one or more previous blocks of the side chain to which the identified block of the side chain 200 is linked are determined. For example, where the identified block is the nth block of the side chain, the (n−1)th block is determined. More generally, any one or more of the 1^{st}, 2^{nd}, (n−2)th, . . . (n−1)th blocks may be determined.

In a seventh step 27, one or more of these blocks is identified that surpasses a threshold probability of finality. For a proof of work blockchain, the probability of a block becoming an orphaned block (which does not form a part of the eventual longest blockchain) decreases as the number of following blocks increases and/or as the depth of the block on the blockchain increases. That is, the (n−1)th block is more likely to become an orphan block than the (n−2)th block, and so on.

Therefore, the probability of finality of each block of the side chain 200 can be assessed by considering the depth of that block in the side chain.

Using Bitcoin as an example, for most transactions a depth of six blocks (or six confirmations) is considered to be sufficient. This gives a risk of less than 0.1% that the block will not present in the final Bitcoin blockchain. For different blockchains, the desirable depth may vary, e.g. the desirable depth may depend on the difficulty of the cryptographic problem that must be solved to mine a block.

Equally, the sufficient depth (and the threshold probability of finality) may vary depending on one or more of: a transaction present in the side chain 200; a feature of the side chain itself (e.g. where a plurality of side chains exist a different probability of finality may be required for each side chain); a determined risk; and a mining time. The required threshold probability of finality is typically defined by information stored on the main chain 100 (e.g. in the side chain side contract).

In an eighth step 28, the determined block(s) are included on the main chain 100. As described with reference to FIGS. 5, this typically comprises the determined block(s) being included in a block of the main chain.

While the eighth step 28 here comprises including the determined block(s) on the main chain 100; more generally, the eighth step may comprise verifying the determined block(s) are suitable for inclusion on the main chain (e.g. a verifying node may pass the block(s) to a miner for said miner to add the block(s) to the main chain).

The method 20 of FIG. 6a has been described as determining in the seventh step 27 one or more of the previous blocks of the side chain that surpass a threshold probability of finality. Equally, such a determination may be carried out an earlier stage, such as before the second step 22. For example, one or more blocks of the side chain may be evaluated to determine a probability of finality before any of the other steps. This may comprise identifying a block that has reached a certain depth in the side chain 200. More generally, the third step 23, the fourth step 24, the fifth step 25, and/or the sixth step 26 may be carried out on the block that surpasses a threshold probability of finality in order to determine that this block is a valid block (since it is this block that will be recorded on the main chain). If a block surpasses the probability of finality threshold it is unlikely that this block is invalid; this is particularly true if the most recent block is valid (since this would require a number of, probably honest, miners to have built on this invalid block). Therefore, the very fact that a block surpasses this threshold can be taken as some indication of validity; however, the described checks may still be worthwhile. This consideration equally applies to the below described method of FIG. 6b.

Referring to FIG. 6b, there is described an exemplary detailed method 30 of including a reference to a block of the side chain 200 in a block of the main chain 100 where the side chain uses a proof of stake system. It will be appreciated that the aspects of this more detailed exemplary method may be used in any combination and in differing implementations only a subset of the following steps are performed.

A first step 31, a second step 32, a third step 33, a fourth step 34, and a rejection step 38 of the method 30 for a proof of stake system are equivalent to the first step 21, second step 22, third step 23, fourth step 24, and rejection step 29 of the method 20 for the proof of work system.

In a fifth step 35, which differs from the fifth step 25 of the method of FIG. 6a (for the proof of work blockchain), the header of the identified block is examined for signatures from relevant parties. For a block to be valid in a proof of stake system, the block must be validated by a certain number of parties who hold a stake in that system. The approval of these parties is typically demonstrated by the inclusion of their signatures (e.g. a digital signature encrypted with a private key) in the header of the block.

In a sixth step 36, it is determined whether the stake held by the signatories exceeds a threshold stake. The stake held by the signatories is related to the probability of finality, where the signatories holding a high stake provides relative certainty that the block will not be orphaned. As with proof of work systems, the requisite probability of finality—and the requite stake of the signatories—may depend on the main chain 100, the side chain 200, and/or the identified block. Typically, a stake of at least ⅓ is required (e.g. the signatories of the block are required to hold ⅓ of the entire pool of coins for the blockchain); in some embodiments, a stake of ½ or ⅔ is required.

In a seventh step 37, that is comparable to the eighth step 28 of the method 20 for the proof of work system, the identified block is included on the main chain 100.

As with the method 10 of FIGS. 5, the methods 20, 30 of FIGS. 6a and 5b are typically performed by a computer device, e.g. the computer device 2000 of a validating node. The identification, determination, etc. that occurs in the methods 20, 30 of FIGS. 6a and 5b is then carried out by this computer device and/or by a combination of the computer device and a party controlling the computer device.

The previous methods have described a block of the side chain 200, or a reference to a block of the side chain, being included in the main chain 100. The inclusion of this block/reference takes space that could otherwise be filled with other transactions (that might offer transaction fees to the miners of the main chain). Therefore, features may be put in place in order to incentivise the miners of the side chain and/or the main chain to include the reference to the block of the side chain in a block of the main chain. As an example, the side chain may be arranged so that miners/proposers of the side chain receive a reward for participating in the addition of a block of the side chain only when that block is included in the main claim. Similarly, miners/proposers who include the reference to the block of the side chain may receive a reward relating to the main chain (such as a number of coins of the main chain) and/or a reward relating to the side chain (such as a number of coins for the side chain). As with other transactions, the inclusion of the reference of the block of the side chain on the main chain may lead to the miner/proposer receiving transaction fees, where the transaction fees may relate to the main chain and/or the side chain. The transaction fees for including the block on the main chain may be specified in the block of the side chain, where these transaction fees are only transferred once the block is recorded to the side chain. This can be achieved by the side chain block including a reference to a side chain smart contract function on the main chain.

### Trustless Interoperability

In some embodiments, it is desirable for actions that occur on the main chain 100, or information that is stored on the main chain, to affect the operation of the side chain 200 and/or vice versa. As an example, it is desirable to be able to transfer coins between the main chain and the side chain.

In order to enable such interaction, in some embodiments, the main chain 100 is arranged to comprise a smart contract relating to the side chain 200. The side chain smart contract (that is recorded on the main chain) may comprise one or more of:
Information about transactions recorded on the side chain.
A record of transactions and/or blocks of the side chain.
Rules regarding allowable transactions for the side chain.
Rules regarding the inclusion of information about the side chain on the main chain (e.g. which blocks of the side chain can be added to the main chain).
Information about the current status of the side chain.
Information about the current recording status (e.g. information about the last block of the side chain that has been added to the main chain).
Consensus information relating to the consensus rules for the side chain. The consensus information may be immutable, or the consensus information may be alterable. This may be used to alter the rules for adding a block to the sidechain (e.g. to alter the difficulty of a relevant cryptographic problem).
Legitimacy information relating to the legitimacy of a fork of the side chain. The smart contract may comprise an indication of a fork of the side chain that is legitimate. For example, this may be the longest fork of the side chain, or the longest fork of the side chain that includes the last side chain block recorded on the main chain.
Functions that interpret transactions in a block of the side chain; e.g. so that a block of the side chain that is recorded on the main chain can cause a transaction on the main chain.

In some embodiments, the side chain smart contract is arranged to act upon information that is recorded on the side chain 200. In particular, information may be included in a block of the side chain, where this block is later recorded on the main chain 100. This information in the block of the side chain may be identified by the side chain smart contract and/or used to execute a function defined with reference to the side chain smart contract. Typically, a node of the main chain is arranged to execute a function defined on the main chain (e.g. by the side chain smart contract) based on information in a block of the side chain that the node is proposing for addition to the main chain.

The side chain smart contract provides a straightforward mechanism for users to review the side chain 200 via the main chain 100. Furthermore, the use of the side chain smart contract enables interaction between the main chain and the side chain.

Typically, the side contract smart contract is recorded on the main chain 100 when the side chain 200 is first linked to the main chain (e.g. the main chain 100 is configured to comprise the side chain smart contract). In some embodiments, the side chain is dependent on the side chain smart contract, and the side chain is initiated at the same time as, or after, the recording of the side chain smart contract on the main chain.

Typically, the side chain 200 is arranged to be dependent on the main chain 100. In particular, the side chain (and/or the nodes of the side chain) may be arranged to monitor the main chain in order to identify changes to the side chain smart contract that is stored on the main chain. This may comprise the nodes of the side chain being arranged to evaluate the main chain and/or the side chain smart contract on the main chain in order to propose and/or validate a block of the side chain. The consensus rules of the side chain may be dependent on information recorded on the main chain. In particular, a state of the side chain smart contract may affect the consensus rules of the side chain. In this way, changes to the side chain smart contract may alter the consensus rules for the side chain, e.g. by forbidding certain transactions and/or by altering the requirements for building consensus on the side chain. Equally, the side chain may be arranged to monitor the main chain in order to identify an illegitimate block and/or fork of the side chain. Furthermore, the side chain may be arranged to determine a legitimate block and/or fork of the side chain based on information (e.g. the side chain smart contract) recorded on the main chain.

Such a dependency may be implemented via the consensus rules for the side chain 200. In some embodiments, some or all of the consensus rules for the side chain are defined by the side chain smart contract. The consensus rules may comprise: a cryptographic problem that must be solved to add a block; the difficulty of a cryptographic problem (e.g. the number of leading zeros required for an acceptable hash); and/or the number of stakeholders required to validate a block. These consensus rules may require consideration of the main chain 100 as part of the consensus process for adding a block to the side chain.

In some embodiments, part of the verification of a transaction included in a block of the side chain 200, which occurs before the block is proposed and/or mined, comprises a comparison to the rules stored in the side chain smart contract. Equally, the verification of a block of the side chain may comprise a comparison to the rules stored in the side chain smart contract.

Typically, the side chain 200 is configured such that for a block to be added to the side chain, the block and/or transactions in the block must be in accordance with rules on the side chain smart contract on the main chain. This can lead to a lag time, where transactions may appear in a number of blocks of the side chain before they reach sufficient probability of finality to be recorded in the main chain. In practice, this lag time tends not to be problematic since many users of blockchains are used to not accepting a transaction (e.g. agreeing that a payment has been made) until the transaction has reached a certain block depth.

Furthermore, the side chain 200 may comprise a system that enables finality to be reached quickly. In particular, proof of stake sidechains, such as Algorand, enable finality to be reached instantaneously, which minimises the issue of lag time. This can enable the side chain to be used for everyday transactions.

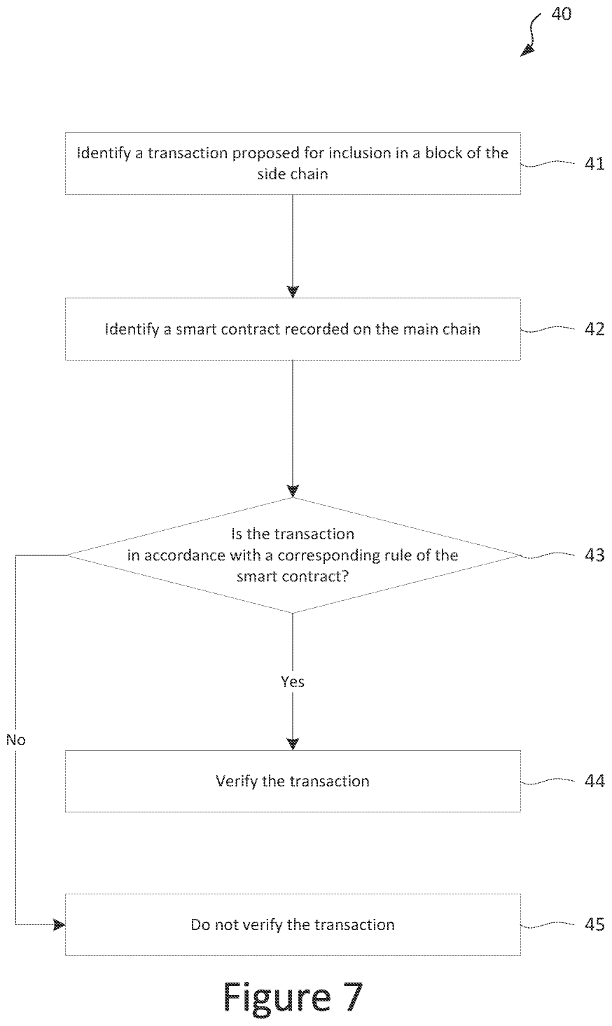

An implementation of a side chain smart contract is shown in FIG. 7, which is a method 40 of verifying a transaction on the side chain 200. Such a method is typically performed by a computer device of a node of the side chain (e.g. a mining node) that is seeking to propose a block for addition to the side chain.

In a first step 41, a transaction is identified that is proposed for inclusion in a block of the side chain 200. This typically comprises receiving a transaction from a node; the transaction may, for example, comprise a monetary transaction, the recording of information, a notification of a status (e.g. a network status), and/or information about system performance.

In a second step 42, a side chain smart contract recorded on the main chain 100 is identified. Typically, this comprises analysing the most recent block of the main chain to identify a most recent version of the smart contract.

In some embodiments, the second step 42 comprises identifying a smart contract in a certain block of the main chain; this certain block of the main chain may be indicated by a block/sequence number and/or a time of addition to the main chain. The certain block of the main chain containing the relevant smart contract may be indicated by one or more of: the transaction proposed for inclusion in the side chain 200; a side chain smart contract recorded in the main chain; a transaction in the main chain; and a further transaction in the side chain. The use of a historic smart contract enables transactions to be made which specify conditions for future transactions and also enables transactions to be planned with certainty (with an awareness that the planned transaction will be subject to presently known rules). As an example, a first user may transfer an amount of a cryptocurrency to a second user on the condition that this amount is later transferred to a third user. This condition can be recorded in the smart contract in the nth block of the main chain prior to, or just after, the transfer from the first user to the second user. By making the future transfer of the cryptocurrency dependent on the smart contract in the nth block, each user is certain that the condition cannot be breached by an overriding or conflicting condition recorded in a later block, such as the (n+1)th block.

In a third step 43, the proposed transaction is checked for accordance with a rule of the side chain smart contract. This rule may relate to, and/or restrict, one or more of: a party that can be involved in a transaction; a party that can initiate a transaction; an allowed purpose for a transaction; an allowed transaction size; an allowed transaction time.

Equally, the third step 43 may comprise checking a proposed block for accordance with a rule of the side chain smart contract. The rule may relate to: a required stake, a cryptographic problem to be solved, and/or an acceptable proposer and/or validator for the block.

In a fourth step 44, if the proposed transaction is in accordance with the rule, the transaction is verified. This transaction may then be included in a block that is proposed for addition to the side chain 200. The fourth step may further comprise including the transaction in the side chain 200 and/or confirming that the transaction is valid and can be included in the main chain 100.

In a rejection step 45, if the proposed transaction is not in accordance with the rule, the transaction is not verified. This may result in the transaction not being included in, and/or being removed from, a block being proposed for addition to the side chain 200.

The method 40 of FIG. 7 may be carried out by a miner or block proposer before including the transaction in a proposed block. Equally, the method may be carried out by a validating node that is confirming the validity of a block of the side chain 200 (e.g. before a reference to this block is added to the main chain 100). Validation of a block of the side chain may comprise verifying that each of the transactions in that block is in accordance with relevant rules of the side chain smart contract stored on the main chain.

Alterations to the side chain smart contract, and/or the performance of operations in accordance with functions of the smart contract, may be implemented by the direct addition of information to the main chain 100 and/or by the addition of information to the side chain 200, which is then recorded on the main chain as described above.

In various embodiments, the side chain smart contract is updated, rules are enforced, functions are modified, and/or operations (e.g. transactions) are carried out, at differing points, for example:
after a confirmation period. For example, rules may be associated with an nth block of the side chain 200, but not updated on the main chain 100 until a confirmation period has passed, e.g. until the (n+6)th block of the side chain. This provides the network and users considering the side chain time to identify the updated rules. The confirmation period may also depend on the side chain so that a rule may be associated with the mth block of the side chain but not applied until the (m+c)th block, with c being a confirmation period.
upon addition to the main chain 100. This may involve, e.g., rules being added directly to the main chain or being added to the main chain via the side chain 200. Where rules are added via the side chain, these rules are added to the main chain via the process described above. Since blocks from the side chain are typically not added to the main chain unless there is a high probability of finality, this results in updates to the rules not occurring unless there is a high probability that these rules will remain in force. Similarly, operations that are defined by information added to the smart contract (e.g. transactions between a plurality of parties, or the transmission of confirmation to a certain party) may be executed only when the block containing this information is recorded on the main chain 100. This recording may be determined by the party mining the relevant block on the main chain or by a node that monitors the main chain to identify that the relevant block has been recorded. In a more basic example, a transaction between two parties that is recorded in a block of the side chain may be completed when this block is referenced by, or recorded on, the main chain. In effect, where the transaction is monetary, the recipient of the transaction is not able to spend the associated cryptocurrency until the transaction is recorded on the main chain.

In some embodiments, the side chain smart contract is configured to only act on information that is first recorded in the side chain 200 (and thereafter recorded on the main chain 100, e.g. using the methods described above). For example, functions of the smart contract may only be called by transactions that first appeared in a block of the side chain. In other embodiments, the smart contract can act on information recorded on the main chain. This may, for example, enable transactions using a side chain cryptocurrency to be initiated on either the side chain or the main chain. Transactions initiated on the main chain may subsequently be recorded on the side chain. The side chain (and/or nodes on the side chain) may be configured to monitor the main chain and to include in a subsequent block of the side chain any transactions that appear in the side chain smart contract but not the side chain itself.

The use of the side chain smart contract on the main chain 100 enables the implementation of an alternative two-way peg. The two-way peg is a mechanism that enables the transfer of coins between the main chain 100 and the side chain 200. Typically, a two-way peg is achieved by coins being locked on a main chain via a transaction (e.g. by sending these coins to a certain address); a user and/or node of the side chain is capable of identifying (but not required to identify) this transaction, and presenting proof of this transaction's inclusion in the main chain to a side chain node, whereupon the side chain node will unlock/mint a corresponding amount of coins on the side chain. A similar process can be used in the other direction, where coins can be locked/burned on the side chain and a corresponding amount transferred on the main chain. This process has been described above as well as in “Adam Back et al. Enabling blockchain innovations with pegged sidechains. https://blockstream.com/sidechains.pdf, (2014)”.

An alternative method for implementing a two-way peg using a side chain smart contract recorded on the main chain 100 comprises a request being recorded in accordance with a function of the smart contract. This request may be recorded directly on the main chain 100 or may be recorded on the main chain via the side chain 200 such that a function of the smart contract is executed. In particular:
Where the request relates to coins of the main chain being exchanged for coins of the side chain, the side chain smart contract is updated to require an amount of coins to be released on the side chain in a future block of the side chain. In order to update the side chain smart contract, the request can be initially recorded on either the side chain or the main chain, e.g. the request may be contained in a block added to the side chain, which block of the side chain is then recorded on the main chain. An amount specified by the request is typically unlocked/minted in a future block of the side chain, where the unlocking/minting of these funds may be required for the future block to be valid. In particular, the consensus rules of the side chain, which are (at least in part) defined in the side chain smart contract on the main chain, may require the amount to be released/minted in a future block of the side chain. This may comprise a node on the main chain and/or the side chain evaluating the side chain smart contract on the main chain and identifying the request.
Where the request relates to coins of the side chain being exchanged for coins of the main chain, the side chain smart contract on the main chain is arranged to identify that an amount of coins have been locked/burned on the side chain and the side chain smart contract is then updated so that a corresponding amount of coins are unlocked/minted on the main chain. Again, this may comprise a node on the main chain and/or the side chain evaluating the side chain smart contract on the main chain and identifying the request. This may comprise the side chain smart contract releasing an amount of coins on the main chain that have previously been locked in relation to the side chain smart contract—so this process can be implemented using an existing blockchain as the main chain, and this does not require the consensus rules of the main chain to be altered.

The smart contract may be arranged to identify a transfer request, such that the locking/minting and unlocking/burning of the coins is performed automatically based on the smart contract. That is, instead of a user manually transferring coins to/from a locking address (for either the main chain 100 or the side chain 200), the smart contract may be arranged to generate a suitable address and/or include such a transaction in a block based on identifying a corresponding request that has been included in the side chain. This may comprise the nodes of the main chain and/or side chain being arranged to monitor the smart contract and/or to execute relevant functions of the smart contract (e.g. based on information in a block of the side chain that is being recorded on the main chain).

In an example, and as before considering a main chain that is Bitcoin and a side chain that is Ethereum, a transaction may be included on the side chain 200 that transfers an amount of Ether to a certain address associated with side chain to main chain transfers. This transaction, and/or the block containing this transaction, is then recorded on the main chain 100. The transaction may, for example, be recorded on the main chain when the related block is six blocks deep on the side chain (e.g. it has met a threshold probability of finality). The side chain smart contract on the main chain may be configured to identify this transaction (e.g. to identify that coins have been sent to a certain address) and to initiate a transaction on the main chain in dependence on the identified transaction. Specifically, nodes of the main chain may be arranged to execute the smart chain side contract so as to identify this transaction. For example, the main chain may initiate a transfer of Bitcoin from an address on the main chain to an address referenced in the transaction on the side chain. A similar process may be used to transfer coins from the main chain to the side chain. A feature identifying a chain to chain transfer (e.g. a certain address to which coins must be sent) may be recorded on the side chain smart contract, where this feature may be updated regularly, irregularly, and/or periodically.

By requiring transactions to have met a threshold probability of finality, syncing issues between the main chain 100 and side chain 200 (and a plurality of blockchains more generally) are mitigated. In particular, a party using the main chain 100 can be confident that the transaction on the side chain 200 is final once it is added to the main chain. This party is then confident that the requisite amount of Ether has been locked on the side chain. The recording of blocks of the side chain on the main chain only once a threshold probability of finality has been met enables the user to identify in a simple manner (or automatically) that the side chain transaction is effectively final.

The smart contract may be arranged to identify a transaction that relates to a transfer from the main chain 100 to the side chain 200. The smart contract may also identify that this transfer has reached a certain block depth and/or probability of finality in the main chain before the smart contract indicates that action should occur on the side chain (e.g. the unlocking of an asset corresponding to an asset locked on the main chain).

In some embodiments, the side chain smart contract is arranged to execute a function based on information recorded on the main chain 100 (e.g. via the side chain 200) and the side chain is arranged to execute a function and/or record a transaction based on a change to the side chain smart contract. This can be used to implement a smart contract and/or a state machine that is split over the main chain and the side chain.

In a practical example, information may be included in a block of the side chain 200, which information is then recorded on the main chain 100 (as described with reference to FIG. 4). This information may be used to execute a function of the side chain smart contract (e.g. to change a state of the side chain smart contract from A->B). The consensus rules defined by the side chain smart contract may then cause a related change to be recorded on the side chain (e.g. the consensus rules may require a transaction to be added to the side chain that relates to a change in the state from B C). This process may repeat so that information added to the side chain is useable to iteratively operate a function on the side chain smart contract, where the functions executed by the side chain smart contract on the main chain cause related changes (e.g. transactions) on the side chain.

### Migration

In some embodiments, the main chain 100 and/or the side chain 200 is arranged to enable migration of the information on the side chain to the main chain. This is particularly useful where the validation throughput of the main chain is increasable (e.g. by increasing the number of transactions in each block). In these embodiments, an increase in the validation throughput of the main chain might result in the side chain no longer being required; indeed, this might result in the main chain being able to handle the validation load of both the main chain and the side chain. In such instances, it is typically desirable to maintain the side chain in order to maintain a record of the transactions that have occurred on the side chain and/or enable continued use of a side chain cryptocurrency.

Referring to FIG. 8, there is described a method 50 of migrating information from the side chain 200 to the main chain 100. This method may be carried out by a node of either blockchain and/or by one or more parties interested in migrating the side chain. For example, a first step 51 of the method may be performed by a party initially configuring the side chain with a fifth step 55 performed by a party migrating the side chain at a later date. Equally, the smart contract may be configured such that certain steps are carried out automatically (e.g. without specific user input).

In the first step 51, the set of consensus rules for the side chain 200 are recorded (included) on the main chain 100 (e.g. in a side chain smart contract that is recorded on the main chain). Typically, this occurs when the main chain and the side chain are first linked.

In a second step 52, the included consensus rules are activated for the main chain 100. Typically, this comprises a command being recorded on the side chain 200 and thereby recorded on the main chain, where this command enables transactions added directly to blocks of the main chain to be checked for accordance with the included consensus rules. This enables the side chain to be controlled by the recording of information on the main chain. The activation may comprise setting a flag in a block of the side chain and/or identifying a block relating to the activation on the side chain that is signed by a threshold (e.g. a majority) of users or stakeholders of the side chain. The side chain smart contract is configured to identify and act upon the activation of the consensus rules.

In a third step 53, a transaction and/or function is received by the main chain 100. Typically, this involves a new block being added to the main chain where the new block contains a transaction, e.g. a transaction that relates to the side chain 200. The transaction may comprise a call to the side chain smart contract function that is recorded on the main chain (e.g. there may be a transaction included in a block that comprises two addresses on the side chain—a sender and a recipient—an amount, and a smart contract reference) and/or the call may be a conventional transaction involving two addresses on the main chain.

In a fourth step 54, this transaction is checked for accordance with the activated consensus rules. The requirements to meet the activated consensus rules may be the same as for side chain transactions (e.g. a certain proportion of the side chain stakeholders may need to approve the transaction), or the rules may be modified after activation (e.g. after activation a certain proportion of the stakeholders of the combination of main chain 100 and the side chain 200 may need to approve the transaction).

In the fifth step 55, if the transaction is in accordance with the activated consensus rules, the main chain 100 is updated accordingly (e.g. the transaction is included on the main chain). This typically comprises updating the side chain smart contract that is recorded on the main chain. In such a way, the side chain 200 (which is effectively nested within the main chain) can be maintained while remaining distinct from the remainder of the main chain. More specifically, the updating of the main chain typically comprises adding a new block to the main chain, where the new block contains an updated side chain smart contract. The side chain may also be updated with the validated transactions. Typically, this occurs by the side chain being configured to monitor the main chain and to add new blocks (optionally automatically) when the side chain smart contract on the main chain is updated.

Typically, the smart contract is arranged to receive instructions from, and execute transactions and functions based on, information recorded on the side chain 200. In order to update the side chain smart contract, a transaction must then be made on the side chain. Indeed, in some embodiments this is the primary purpose of the smart contract—recording on the main chain 100 information/transactions that have been added to the side chain. In these embodiments, the activation of the consensus rules may enable information to be added to the side chain from the main chain. This may involve the side chain mirroring the main chain and/or the side chain including blocks in dependence on an input to the main chain. For example, transactions added to the main chain that demonstrate they meet the consensus rules for the side chain may be added to the side chain. In this way, coins relating to the side chain can be transferred via the addition of blocks to the main chain.

In some embodiments, the activation of the consensus rules for the main chain 100 does not prevent the direct addition of blocks of the side chain 200. However, this may result in confusion if the same coins are referenced in a block added to the side chain and a block added to the main chain. Therefore, in some embodiments, the activation of the consensus rules for the main chain results in only the main chain being useable to initiate transactions on the side chain. This may be achieved by the inclusion of a smart contract on the side chain that detects the activation of the consensus rules and thereafter prevents transactions from being included other than via the main chain (e.g. by updating consensus rules for the side chain). In some embodiments, after the activation of the consensus rules, the side chain is arranged to monitor the main chain and the side chain is arranged to no longer receive blocks from miners. In particular, the side chain may be arranged to automatically add blocks in dependence on the main chain, e.g. in dependence on the side chain smart contract recorded on the main chain. The side chain typically remains available to view, so that users of the side chain can still track transactions that utilise the side chain, but the side chain may no longer be available for the manual/direct/user-driven addition of blocks.

More generally, the activation of the consensus rules on the main chain may alter the consensus rules of the side chain (e.g. by altering consensus rules defined by the side chain smart contract on the main chain). As described above, this alteration typically comprises the consensus rules of the side chain being altered such that blocks can no longer be added to the side chain.

In some embodiments, the activation of the consensus rules on the main chain 100 enables transactions made using the side chain 200 to be validated by the nodes of the main chain. This validation may be based on consensus rules for the side chain or may be based on consensus rules for the main chain. In some embodiments, following the activation of the consensus rules on the main chain, transactions on the side chain are validated using the systems (e.g. nodes) and/or rules of the main chain; this enables the miners of the side chain to apply their resources elsewhere while also enabling use of the side chain to continue. The use of the side chain may continue as before, merely with the miners of the side chain (e.g. the miners of the main chain) applying different consensus rules when proposing and/or adding blocks to the side chain.

In some embodiments, the activation of the consensus rules on the main chain 100 results in assets held on the side chain 200 being transferred to the main chain. As an example, each Ether token held on the side chain may be locked and a corresponding amount of Bitcoin may be transferred to the holders of that Ether. In this way, the information stored on the side chain can be fully transferred to the main chain. It will be appreciated that while assets can be monetary, they may also be non-monetary.

The above description has considered the main chain 100 comprising consensus rules for the side chain 200. More generally, the main chain and/or a block of the main chain may comprise a flag relating to the side chain, where this flag is useable to identify that migration is occurring. The occurrence of migration (e.g. the activation of the flag) may:
Indicate (e.g. to the nodes of the main chain and/or the side chain) that migration is occurring.
Alter some or all of the consensus rules for the side chain. For example, alter some or all of the consensus rules for the side chain that are embedded in the main chain.
Prevent the addition of new transactions and/or blocks to the side chain.
Prevent the addition of new transactions and/or blocks that are not based on the main chain to the side chain by nodes of the side chain (but still enable automatic addition of blocks, e.g. based on the main chain).
Prevent the addition of (references to) blocks of the side chain to the main chain.
Transfer assets from the side chain to the main chain (e.g. lock assets on the side chain and unlock/generate a corresponding amount of assets on the main chain).

Migration is particularly beneficial when the validation throughput of the main chain 100 increases; in this case, the side chain may become redundant. Migration enables the side chain to be retired while transferring the assets of the side chain to the main chain.

In some embodiments, the side chain 200 is dependent on the main chain 100. For example, an asset of the side chain (e.g. a cryptocurrency) may be tied to an asset of the main chain. This asset may have a value that is the same as the asset of the main chain. Such an arrangement is useful where the side chain is used primarily to increase the validation throughput of the main chain.

### Staged Migration

The above description has described consensus rules and/or a flag being activated to cause the migration of information and/or assets from the side chain 200 to the main chain 100. Such migration may also be arranged to occur in a staged manner (‘staged migration’).

In particular, information, transactions, and/or accounts on the side chain 200 may be grouped where the migration process occurs separately for separate groups. This may comprise one or more of:
Altering the consensus rules and/or transaction rules for different groups at different times. As an example, transactions relating to a large amount of an asset may be prohibited from addition to the side chain as soon as the migration flag is activated, whereas transactions relating to a smaller amount of the asset are allowed for a further number of blocks of the side chain. This enables parties to settle any small debts and consolidate assets before a transfer between the side chain and the main chain.
Transferring assets from the side chain to the main chain depending on the group. For example, transactions on the side chain may be grouped by project (or by connection to a smart contract), where upon completion of a project (which may be identified by the smart contract) all of the assets on the side chain relating to that project are migrated to the main chain.

Typically, different aspects of the migration method occur and/or are enforced in different blocks. In particular, the consensus rules for the addition of blocks to the side chain may be altered before the transfer of assets from the side chain to the main chain. This can be used to prevent transactions being added to blocks of the side chain for a certain number of blocks so as to ensure all transactions have reached finality before the transfer to the main chain. To achieve this, the consensus rules may be altered to require a number of blocks without transactions or state changes (‘empty’ blocks) to be mined by nodes; while the nodes typically would not receive transaction fees for this mining, the nodes may still receive a block proposal reward.

Where staged migration occurs, a similar migration process may occur separately for each group. Therefore, the occurrence of migration (e.g. the activation of the flag) may:
Indicate (e.g. to the nodes of the main chain and/or the side chain) that migration for a particular group is occurring.
Alter some or all of the consensus rules for the side chain for transactions and/or blocks relating to the group.
Prevent the addition of new blocks and/or transactions to the side chain, which blocks/transactions relate to the group. For example, parties (e.g. blockchain addresses) in the group may be unable to participate in transactions following the activation of the flag.
Prevent the addition of new blocks and/or transactions that are not based on the main chain to the side chain by nodes of the side chain, which new blocks relate to the group (but still enable automatic addition of blocks, e.g. based on the main chain).
Prevent the addition of (references to) new blocks and/or transactions of the side chain to the main chain, which new blocks and/or transactions relate to the group.
Transfer assets from the side chain to the main chain for the groups (e.g. lock assets on the side chain and unlock/generate a corresponding amount of assets on the main chain).

In some embodiments, there exist a plurality of flags, where each flag relates to a different group. The nodes of the main chain 100 and/or the side chain 200 may be able to activate different flags at different times so that migration occurs differently for the different groups. Typically, this comprises a flag relating to a group being included in a block of the side chain; the recording of this block of the side chain in the main chain then causes migration to begin for the group. A further flag relating to a further group may be included in the side chain at a later time (e.g. in a later block of the side chain); the recording of this further flag on the main chain causes migration to begin for the further group.

A flag may be included on the side chain 200 in an inactive state before migration is initiated (e.g. where the flag indicates migration is not occurring) and this flag may then be changed to an active state in order to initiate migration. Equally, the flag may be first included in the side chain when a party wishes to initiate migration.

### Recoverability

With blockchains, there is a, typically unavoidable, risk of a malicious actor gaining control of the blockchain (e.g. by obtaining a majority of the system hash rate in a proof of work system or by obtaining a controlling stake in a proof of stake system). Furthermore, through fortune, coincidence, and/or identifying a programming error a party without a majority stake may be able to add fraudulent transactions to a block that is included in a blockchain or to benefit unjustly (e.g. by stealing cryptocurrency). Where this happens, it may be desirable to reset the blockchain, e.g. to recover an old version of the blockchain so as to reverse any fraudulent or underhanded actions that have occurred. One solution is to revert to a previous block and fork the blockchain (e.g. if the nth block is a fraudulent block the users of the blockchain may agree to mine a new fork of the blockchain from the (n−1)th block). However, where such a method is discussed after the fact (e.g. after a theft is identified) it can be difficult to reach consensus between all users/stakeholders on the recovery of the blockchain. Typically, some users will support the fork and some will reject it and this can lead to the blockchain fracturing.

Referring to FIG. 9, there is described a method 60 of recovering the side chain 200 based on the information stored on the main chain 100. This method is typically carried out by the computer device of a node of the main chain and/or the side chain, e.g. a validating node.

In a first step 61, a block of the side chain 200 is identified. This identified block may be a block of the side chain that has already been included in/referenced by the main chain 100 or this block may be a block of the side chain that has not yet been included in/referenced by the main chain. In some embodiments, the block comprises a block that is being proposed for addition to the main chain.

In a second step 62, it is determined whether an invalidity proof has been submitted for the identified block of the side chain 200. Typically, an invalidity proof is transmitted to a node, which initiates the method 60 so that in practice the second step may be performed before the first step 61. For example, a node may receive an invalidity proof and thereafter identify a corresponding block of the side chain.

The invalidity proof comprises an assertion that a block of the side chain 200 is invalid. Typically, the invalidity proof also comprises evidence to support this assertion. The invalidity proof may identify, for example, a fraudulent transaction (e.g. transferring coins from a non-existent address), and/or a block that relates to a malicious fork away from the legitimate longest chain.

In some embodiments, the invalidity proof comprises a fraud proof, for example as described in “Al-Bassam et al.; Fraud and Data Availability Proofs: Maximising Light Client Security and Scaling Blockchains with Dishonest Majorities; https://arxiv.org/1809-09044.pdf (2019)”. Embodiments of the present invention in which entire blocks of the side chain 200 are recorded on the main chain 100 (and/or in which the entire side chain is recorded on the main chain) avoid the data availability problem that is described in this document, since a trusted version of the entire side chain is accessible via the main chain.

In a third step 63, if no invalidity proof has been submitted it is determined whether a challenge period has expired. It will be appreciated that in some embodiments this third step is carried out after the receipt of an invalidity proof. For example, a node may receive an invalidity proof, identify a corresponding block, and then determine whether the challenge period for that block has expired.

The challenge period may relate to a time, a block depth, and/or a probability of finality on either the main chain 100 or the side chain 200. In some embodiments, only blocks which are less than six blocks deep in the side chain can be challenged (it will be appreciated that this depth can vary in differing implementations). For a proof of stake system, the challenge ‘period’ may relate to the number of signatories for a block, where only blocks having below a threshold number of signatories can be challenged.

In some embodiments, the challenge period is dependent on one or more of: information and/or a transaction in the block of the side chain 200 (e.g. the challenge period may be extended where a large transaction is recorded in the block); a party involved in a transaction in the block of the side chain (e.g. the challenge period may be extended if a potentially untrustworthy party is identified); and/or a feature of the side chain (e.g. the difficulty of a proof of work problem of the side chain).

Typically, the challenge period relates to a block depth and/or a probability of finality of a block of the main chain 100. As an example, a reference to a block of the side chain 200 may need to reach a block depth of six blocks on the main chain before the challenge period for that block of the side chain expires.

An example of the challenge period is now described with reference to FIG. 2. This example is of particular relevance where both the main chain 100 and the side chain 200 are proof of work blockchains:
As described in the method 10 of FIGS. 5, the mth block 202 of the side chain typically needs to reach a threshold probability of finality to be recorded on the main chain. Therefore, the mth block of the side chain may be recorded in the (n+3)th block 108 of the main chain (when this mth block has reached a block depth of six on the side chain).
The challenge period considered typically relates to a threshold probability of finality on the main chain. Therefore, the challenge period may only expire when the (n+3)th block of the main chain (in which the mth block of the side chain is recorded) reaches a certain block depth. For example, the challenge period may only expire when an (n+9)th block is added to the main chain. Typically, the challenge period relates to a high probability of finality of a block of the main chain (e.g. a greater probability of finality than is required for a block of the side chain to be added to the main chain). This ensures that the block of the main chain in which the challenge period expires will not be orphaned. Therefore, the expiry of the challenge period typically relates to a block depth, e.g. a block depth greater than six, greater than ten and/or greater than fifteen. In some embodiments, the expiry of the challenge period relates to a block of the main chain (on which a block of the side chain is referenced/recorded) exceeding a threshold probability of finality of 99%, 99.9%, 99.99%, and/or 99.999%.

There may be a required side chain threshold of finality (e.g. a threshold of finality relating to a block of the side chain 200) required for a reference to a block of the side chain to be recorded on the main chain and thereafter a required main chain threshold of finality (e.g. a threshold of finality relating to a block of the main chain 100) required for the referenced block of the side chain to pass beyond the challenge period. These required thresholds of finality may differ, e.g. the required probability of finality may differ. Typically, the main chain and the side chain comprise blockchains with different consensus mechanisms. The main chain may be a proof of work blockchain such that the challenge period relates to a block depth (e.g. a depth of three blocks, six blocks, seven blocks, and/or ten blocks) and the side chain may be a proof of stake blockchain where the addition of a block of the side to the main chain depends on a stake held by validators of that block.

In a fourth step 64, if no invalidity proof has been submitted before the expiry of the challenge period, a reference 47 to the identified block is included in the main chain 100 (e.g. as described with reference to the fourth step 14 of the method 10 of FIG. 5). The challenge period may be related to the probability of finality (as described with reference to the third step 13 of the method of FIG. 5), so that the challenge period expires at a similar, or the same, time as the achievement of a suitable probability of finality. Therefore, the existence of an invalidity proof may be determined at the time of adding a (reference to a) block of the side chain to the main chain.

In particular where the challenge period relates to the side chain, the challenge period may be the same as, or shorter, than the depth required to achieve a threshold probability of finality (or relates to the same number of, or fewer, signatories than are required to achieve a threshold probability of finality). This ensures that only blocks of the side chain 200 that are not already included in the main chain 100 can be challenged. Therefore, the record on the main chain never (or only very rarely) includes an invalid block of the side chain 200.

In some embodiments, the challenge period relates to the side chain and is greater than or equal to the depth required to achieve a threshold probability of finality (or relates to the same number of fewer signatories than are required to achieve a threshold probability of finality). In these embodiments, the side chain information recorded on the main chain 100 (e.g. the side chain smart contract) may be arranged to be able to indicate that a previous side chain reference/block recorded on the main chain is no longer valid. The indication may comprise a flag and/or may comprise a block identifier for the side chain that differs from, or is incompatible with, a block identifier stored in a previous block of the main chain.

Typically, the challenge period relates to the main chain 100, where a reference to a block of the side chain 200 must reach a certain block depth on the main chain for the challenge period for that block of the side chain to expire. In particular in these embodiments, blocks of the side chain may be recorded on the main chain and then challenged, leading to these blocks being found to be invalid. In such cases, information on the main chain (e.g. on the side chain smart contract on the main chain) may identify whether a reference to a block of the side chain has passed the challenge period and/or whether the reference has been challenged. In particular, the main chain may be arranged to identify references to blocks of the side chain that have been successfully challenged and/or to identify a legitimate fork of the blockchain, which legitimate fork does not comprise any blocks that have been successfully challenged.

In some embodiments, blocks of the side chain 200 are not considered legitimate (and/or fully legitimate) until they have passed a challenge period, which challenge period relates to the main chain 100. The main chain may then comprise references to both legitimate and not-yet legitimate (or potentially illegitimate) blocks of the side chain, where the legitimate blocks—those blocks that have passed the challenge period—may be marked on the main chain and/or may be identified due to being a certain number of blocks deep on the main chain.

Where a block of the side chain 200 is found to be invalid, the descendants of this block may also be deemed invalid (e.g. if the mth block of the side chain is invalid, the (m+1) the block is also invalid). This invalidity of each block may be recorded on the main chain.

In some embodiments, the challenge period is limitless, so that a challenge can be raised at any time and in relation to any block of the side chain 10. Typically, a limitless challenge period is not provided, since this can reduce the confidence of users in the side chain.

Therefore, in some embodiments the challenge period relates to a block depth of less than ten blocks, for a proof of work side chain and/or a stake of less than ⅔ for a proof of stake side chain.

In some embodiments, the requirements for the invalidity proof depends on the stage at which a challenge occurs. For example, the requirements for invalidating a block with a depth of six may be more stringent than the requirements for invalidating a block with a depth of one. This may be implemented, for example, by requiring a greater number of invalid transactions to be proved for deeper blocks. With this example, it might be considered that the benefits of cancelling a single fraudulent transaction are outweighed by the consequences of cancelling a number of valid transactions.

While the fourth step 64 of this method comprises adding a reference to the main chain 100; more generally, the expiration of a challenge period may simply mean that a block can no longer be challenged via an invalidity proof. As a result, the fourth step 64 may simply comprise no action being taken (e.g. where a block of the side chain 200 is already referenced by the main chain or has not yet reached a threshold probability of finality for addition to the main chain).

Typically, the challenge period relates to the main chain 100, such that blocks of the side chain 200 may be challenged for a certain period following addition to the main chain. Such an implementation ensures that relevant information relating to a side chain block is recorded on the main chain for the duration of the challenge period such that an invalidity proof can be generated and submitted for that side chain block. This avoids the above-mentioned data availability problem.

In a fifth step 65 that occurs when an invalidity proof is submitted within the challenge period, the invalidity proof is checked. Where the invalidity proof comprises evidence of an invalid transaction, the invalidity proof may be verified by:
a. Identifying a previous state relating to the side chain 200 that is recorded on the main chain 100. For example, identifying a state of an account stored in a side-chain smart contract on the main chain or identifying an amount of a cryptocurrency held by an address of the side chain, the amount and address being previously recorded on the main chain.
b. Executing a transition in relation to the identified block of the side chain. The transition may, for example, relate to a transaction that alters a state of an account or transfers an amount of cryptocurrency between addresses.
c. Verifying that the result of the transition does not match with an expected/required value. For example, the transition may lead to a state that differs from a state specified by the identified block of the side chain. Or an address contained in a block of the side chain may have an amount that is incompatible with the transition.

The above invalidity proof may be used to identify fraudulent transactions, such as transfers from an empty address. In an example, a full node may alter the header of a previous block so that this header refers to a non-existent transaction (e.g. a fictional transfer from account A to account B). This alteration may comprise altering a value relating to a Merkle tree. This full node may then send the altered header to a light node, which light node does not have access to the entirety of the previous block and therefore cannot identify the fictional transfer. The full node may then include in a future block a transaction from account B to account C. Conventionally, the light node would not be able to identify this fraud; however, according to the present disclosure, this alteration can be detected using an invalidity proof, which invalidity proof references the block relating to the altered header. This block is recorded on the main chain, so that any party with access to the main chain is able to receive and verify the invalidity proof (and verify that the fictional transfer is not included in the block).

Furthermore, the above invalidity proof may be used to identify double-spends, where a malicious actor has transferred a coin from account A to account B in an mth block of the side chain 200; waited to receive a good in relation to the payment; and then started a new chain from an (m−1)th block of the side chain by mining a new mth block that does not include the transfer (meaning that the coin can be transferred from account A to another account C). In this example, the owner of account B will typically wait until they have received a certain number of confirmations before releasing the good. For a malicious actor who holds a majority stake in the side chain or who holds a majority of the total hash rate for the side chain this is not a problem in conventional systems; this actor simply wait until the required number of confirmations has occurred and then starts the new fork (and then catch up to the longest fork by dint of having a majority stake/hash rate). However, in the present system, the owner of account B can wait until the mth block has been recorded on the main chain 100. When the malicious actor mines a new mth block, the main chain can be used to identify that this mth block relates to a double spend. The new mth block can then be rejected and the malicious actor can be identified (e.g. it is likely that the owner of account A is a malicious actor).

A specific use of invalidity proofs is to police the two way peg (e.g. where assets are being transferred between the main chain 100 and the side chain 200). The invalidity proof may relate to a transaction that is associated with a transfer of an asset from the main chain to the side chain and/or a transfer of an asset from the side chain to the main chain. Typically, the main chain includes a record of the entirety of the side chain (or at least the entirety of the side chain up to a certain block). Therefore, historic blocks of the side chain that are referenced in an invalidity proof can be examined on the main chain. This enables all the information needed to assess an invalidity proof associated with the two-way peg to be found on the main chain—and this addresses the data availability problem that has been mentioned above.

Typically, invalidity proofs are generated and submitted by honest full nodes of the side chain 200, which invalidity proofs may then be verified by any node with access to the main chain. Full nodes store a full record of the side chain and are able to validate each transaction with reference to previous blocks of the side chain. Light nodes typically assume that the longest chain is legitimate and validate only the most recent block of the side chain. Light nodes may receive information (e.g. block headers) from full nodes, where these block headers enable light nodes to identify the presence of a transaction in a corresponding block (e.g. by comparing a transaction to a Merkle tree value in the header). Problematically, this enables nodes to include invalid transactions in the side chain. Since light nodes assume that the previous blocks of the side chain are valid, invalid transactions (that have a valid form) can be included in a block so long as these invalid transactions are referenced in falsified block headers. As an example, a full node may falsify a block header of the (m−1)th block of the side chain so that a Merkle tree value in this block header indicates account A holds a certain amount of Ether (where in reality account A holds nothing). The full node may then transfer Ether from this account A in the mth block of the blockchain in a seemingly valid transaction. Since the light nodes do not store the entire side chain, they are unable to identify that account A is not able to transfer coins and so the light nodes may incorrectly validate the block.

Since the entirety of the side chain 200 is typically recorded on the main chain 100, the present disclosure enables a single honest full node to generate and provide an invalidity proof to any node where this node can then check the invalidity proof by examining the record of the side chain that is stored on the main chain. With the above example, the light nodes (or indeed, any node of the main chain and/or side chain) would be instructed to review the (m−1)th block of the side chain on the main chain; these light nodes could then identify that account A does not hold any coins (and/or exist). This prohibits malicious full nodes from including invalid transactions where there is a single trustworthy full node.

Typically, invalidity proofs are arranged to be identified and/or verified by the side chain smart contract on the main chain 100. In particular, nodes of the main chain may be arranged to execute a function of the side chain smart contract when proposing and/or validating blocks of the main chain. These nodes may be arranged to execute a function of the side chain smart contract that relates to an invalidity proof, wherein the execution of this function determines whether the invalidity proof is successful.

Typically, the invalidity proof relates to a falsified or invalid block. In some embodiments, the invalidity proof comprises evidence of halting, where blocks have stopped being added to the side chain 200. This evidence may comprise identifying that no blocks of the side chain have been recorded on the main chain 100 for a certain amount of time.

More specifically, where the invalidity proof comprises evidence of halting, the invalidity proof may comprise evidence that a block has not been added to the side chain 200 for a certain amount of time and/or that a block of the side chain has not been recorded on the main chain 100 for a certain amount of time (e.g. a certain number of blocks).

Typically, the challenge period for halting proofs differs from the challenge period for fraud proofs. In particular, whereas the challenge period for fraud proofs typically relates to a number of blocks of the main chain 100 in which a block of the side chain 200 is recorded, the challenge period for halting proofs may relate to a number of blocks of the main chain in which there is no block of the side chain recorded. More specifically, an invalidity proof relating to a halting of the side chain typically requires a certain number of blocks to be added to the main chain, which blocks do not comprise references to the side chain. For example, the challenge period for halting proofs may relate to a block depth of three blocks, six blocks, and/or ten blocks of the main chain. Therefore, if no block of the side chain has been included in the main chain for three blocks of the main chain, any node (of the main chain and/or the side chain) may be able to submit a proof that comprises evidence of this halting. The halting can then be determined by the side chain smart contract on the main chain; this may result in a proposer for a new block of the side chain being determined based on information in the side chain smart contract.

In some embodiments, the invalidity proof comprises a proof that consensus rules have been broken. The invalidity proof may then comprise evidence that a block has been submitted that has not solved a cryptographic problem and/or obtained sufficient signatories.

In some embodiments, the success of the invalidity proof does not rest on the block in question being invalid; instead the invalidity proof may relate to a block that is undesirable or suspicious. For example, if the major signatories of a recent block of a proof of stake side chain begin to divest their stakes in the side chain, it may be desirable to examine and/or invalidate this block. The invalidity requirements are typically encoded in the information (e.g. smart contract) that is stored on the main chain so that all parties can avail themselves of the requirements before the submission of any block.

If the invalidity proof is unsuccessful, the method proceeds to the third step 63 and it is determined whether the challenge period has expired.

If the invalidity proof is successful, then in a sixth step 66 recovery rules are determined from the main chain 100. Typically, recovery rules are stored in a side chain smart contract that is stored on the main chain. These rules, and the use of stored invalidity criteria, indicates to each party the procedure for recovering the side chain 200 before this recovery is necessary. The storage of these rules on the main chain also enables recovery to be enforced via the main chain when the side chain has been hijacked by malicious actors.

Typically, the recovery rules comprise an indication of how a last legitimate block of the side chain 200 is determined. Typically, the last legitimate block may be the latest block of the side chain that is stored on the main chain 100. Equally, the last legitimate block may be the latest block of the side chain that is stored on the main chain and that has also passed the challenge period. As has been described in relation to the fourth step 64, the challenge period typically relates to a lesser depth/fewer signatories than the threshold probability of finality. As a result, blocks of the side chain that are referenced by the main chain—so have exceeded the threshold probability of finality— have typically exceeded the challenge period and are unlikely to be orphaned. These blocks therefore represent an appropriate means of recovering the side chain in the event that invalid blocks are added to the side chain.

The recovery rules may also comprise a consensus threshold, e.g. a number of users that must agree to the recovery for the recovery to occur. With a conventional blockchain, after a recovery some users could continue mining the old unrecovered fork (which could lead to two side chains existing). With the present disclosure this is not possible, since the information stored on the main chain would indicate that the old fork is illegitimate.

Typically, the recovery rules relate to a fork of the side chain that is to be stored on the main chain 200 (e.g. in future blocks of the main chain). While some users might continue to mine the old fork, the newly mined blocks for this old fork are not stored on the main chain 100 and so the old fork loses the benefits obtained by being associated with the main chain.

In a seventh step 67, recovery information is included on the main chain 100. The recovery information typically comprises an indication of a last legitimate block of the side chain 200. Users of the side chain can then extend the side chain from this last legitimate block. Typically, the side chain is configured to obtain legitimacy information from the main chain. This enables the main chain to specify that the a first fork of the side chain is illegitimate and that a second, different, fork (that does not include any invalid blocks) should be treated as the legitimate side chain. In order to determine the legitimate side chain (and determine which chain to extend) users/miners of the side chain may need to review the main chain before adding blocks to the side chain.

In some embodiments, the invalidity proof relates to a block of the side chain.

In some embodiments, the invalidity proof relates to a transaction in a block of the side chain. In such embodiments, a successful invalidity proof may result in a new block being mined that includes each transaction in the block apart from the invalid or fraudulent transaction. Typically, this comprises a node verifying a invalidity proof and then proposing a new block that does not contain the invalid transaction—and the side chain may be arranged such that the submission and/or verification of a successful invalidity proof by a node results in that node being selected as the proposer for a new block. This process may comprise a plurality of new blocks being added to the blockchain (where each block comprises a number of transactions present in invalidated blocks, and wherein for each block each transaction that relates to the invalid transaction is removed).

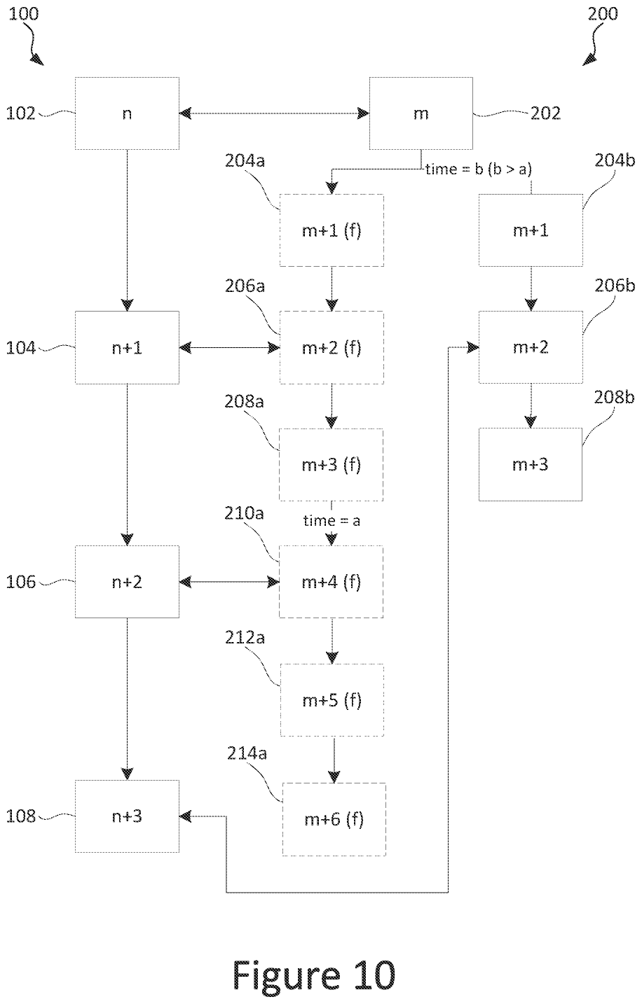

A practical application of the method 60 of FIG. 9 is represented in FIG. 10.

In normal circumstances, there is interaction between the side chain 100 and the main chain 200 as has been described herein. In particular, a mth block 202 of the side chain interacts with an nth block 102 of the main chain; this interaction typically comprises the main chain storing information relating to a block of the side chain. As has been described with reference to previous methods, e.g. with reference to the third step 13 of the method 10 of FIGS. 5, typically the main chain is arranged to store only blocks that have achieved a threshold probability of finality. For the sake of this example, a threshold probability of finality that is a block depth of four is considered, so the mth block of the side chain interacts with the nth block of the main chain such that the (m−3)th block of the side chain is recorded in the main chain.

Following the mth block 202 of the side chain 200, a falsified (m+1)th block 204a is added to the side chain. This falsified (m+1)th block may contain insufficient signatories to add a block to the chain and/or may contain an insufficient transaction. Equally, this falsified (m+1) block may contain a transaction that relates to the theft of an amount of a side chain cryptocurrency. The falsified (m+1) block is followed by a falsified (m+2)th block 206a, a falsified (m+3)th block 208a, a falsified (m+4)th block 210a, a falsified (m+5)th block 212a, and a falsified (m+6)th block 214a.

At the time of addition to the side chain 200, these falsified blocks form a part of the longest chain and so these falsified blocks may continue to interact with the main chain 100. It may not be realised until later on that the falsified (m+1)th block 204a is problematic.

In particular, the falsified (m+2)th block 206a of the side chain 200 interacts with an (n+1)th block 104 of the main chain 100 to request that the main chain stores information relating to a block of the side chain. Since this example uses a threshold probability of finality that is a block depth of four, the (n+1)th block of the main chain stores information relating to the (m−2)th block of the side chain and/or the (m−1)th block of the blockchain.

Thereafter, the falsified (m+4)th block 210a of the side chain 200 interacts with an (n+2)th block 106 of the main chain 100 to request that the main chain stores information relating to a block of the side chain. In the time between the interaction of the (m+2)th block 206a of the side block with the (n+1)th block 104 of the main chain and the interaction of the (m+4)th block 210a of the side block with the (n+2)th block of the main chain an invalidity proof is submitted that relates to the falsified (m+1)th block—this invalidity proof is identified during the second step 62 of the method 60 of FIG. 9. Typically, the invalidity proof is transmitted to a node of the main chain, this node propagates the invalidity proof throughout the nodes of the main chain and the invalidity proof is then considered as a part of the addition (e.g. mining) of the (n+2)th block. This invalidity proof may, for example, be included in the falsified (m+3)th block 208a or in the falsified (m+4)th block 210a. Alternatively, or in addition, the invalidity proof may be transmitted directly to a node to prevent a malicious actor from holding back blocks of the side chain that contain the invalidity proof.

Turning to the interaction between the falsified (m+4)th block of the side chain 200 and the (n+2)th 106 block of the main chain 100, and again using the threshold probability of finality that is a block depth of four, the (n+2)th block of the main chain stores information relating to the (m−1)th block of the side chain and/or the mth block of the blockchain.

The (n+2)th block 106 of the main chain 100 also considers the submitted invalidity proof for the falsified (m+1)th block 204a. In this example, the challenge period is equal to the threshold probability of finality and is a block depth of four. The falsified (m+1)th block is not yet four blocks deep and so, in the third step 63 of the method 60 of FIG. 9, it is determined that the challenge period has not expired.

While this example considers a challenge period that is based on a probability of finality of a block of the side chain, the challenge period is generally dependent on the main chain. Therefore, there may be submitted in the (m+4)th block 210a of the side chain an invalidity proof for the (m−3)th block of the side chain, which (m−3)th block is recorded in the nth block 102 of the main chain. In such an instance, a node of the main chain considering the (n+2)th block 106 of the main chain may determine whether a challenge period relating to the main chain has been exceeded. For example, where the challenge period is a block depth of six on the main chain, it can be determined that the challenge period relating to the (m−3)th block of the side chain, which is recorded in the nth block of the main chain, has not expired (and will not expire until the (n+7)th block of the main chain. In this example, the invalidity proof relating to the (m−3)th block of the side chain may be unsuccessful and so no action is taken by the node.

For the sake of this example, the invalidity proof relating to the (m+1)th block 204a of the side chain is determined to be successful in the fifth step 65 of the method 60 of FIG. 9 and so in the sixth step 66 recovery rules are determined from information on the main chain 100. Typically, this involves the node examining the (n+1)th block 104 of the main chain 100 (bearing in mind that at this point the (n+2)th block 106 has not yet been added to the main chain); the node identifies information in the main chain that relates to recovery rules for the side chain 200. In this example, the recovery rules indicate that the side chain should be reset to the last block of the side chain that has been determined to exceed the threshold probability of finality—this is the mth block 202 of the side chain.

In some embodiments, the recovery rules indicate that the side chain 200 should be reset to the last block of the side chain that is stored in the main chain 100—this would be the (m−2)th block of the side chain that is stored in the (n+1)th block 104 of the main chain.

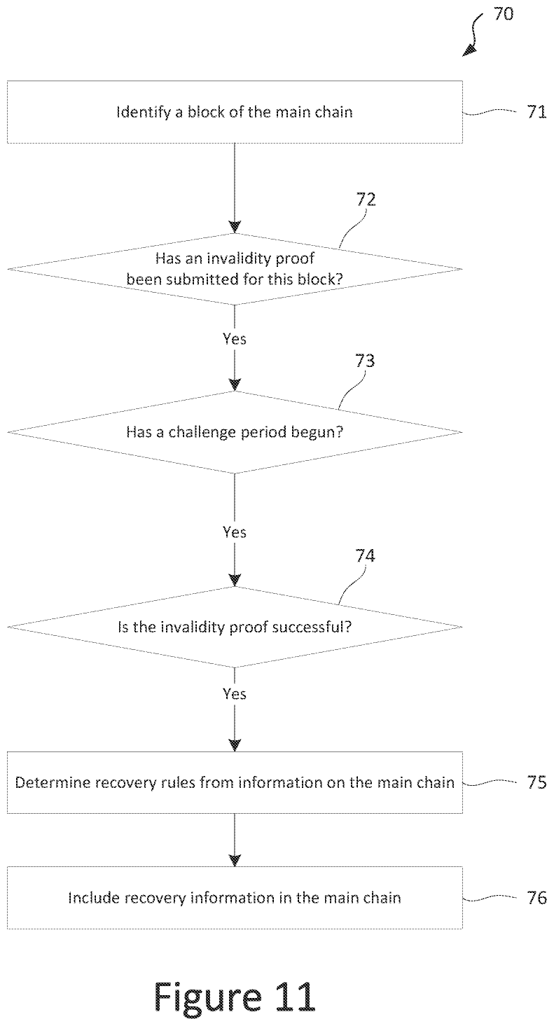

As per the seventh step 67 of the method 60 of FIG. 11, recovery information is then included in the main chain 100. In the example of FIG. 10, this comprises including in the (n+2)th block 106 of the main chain an indication that the mth block 202 of the side chain is the last legitimate block and should be the basis for a new fork.

The side chain 200 is configured to accept the recovery information included in the main chain 100 so that users of the side chain are in agreement that the last legitimate block of the side chain is the mth block 202. This may be achieved by configuring the side chain smart contract on the main chain to specify that only a new fork built from the last legitimate block will be recorded on the main chain. Therefore, following the addition of the (n+2)th block 106 to the main chain the users (e.g. miners) of the side chain begin adding blocks to the mth block of the side chain; specifically, the users of the side chain add a legitimate (m+1)th block 204b, a legitimate (m+2)th block 206b, and a legitimate (m+3)th block 208b.

Typically, the main chain 100 only interacts with forks of the side chain 200 that are entirely formed of legitimate blocks. Therefore, even if the malicious actor continues to build on the falsified fork following the invalidity proof, the main chain will interact with the legitimate fork of the side chain. As such the falsified fork will have a greatly limited value (and will likely be rejected by most users of the side chain). This removes the incentive of the malicious actor to keep building on the falsified fork.

In the example of FIG. 10, the (n+3)th block 108 of the main chain 100 interacts with the legitimate (m+2)th block 206b of the side chain 200 as opposed to the falsified (m+6)th block of the falsified fork of the side chain.

The method 60 of FIGS. 8 and 9 discourages malicious actors from attacking the side chain since any falsified blocks may be orphaned based on an invalidity proof. Further discouragement may be provided to further disincentivise malicious actors. In some embodiments, parties involved with the addition of falsified, invalid, or undesirable blocks are penalised; for example, coins that are owned by signatories of falsified blocks may be locked or burned (destroyed) so that they cannot be used. In some embodiments, parties involved with the addition of falsified or invalid blocks are prevented from further involvement in the side chain 200 or have restricted permissions for the side chain; such punishments are enforceable by updating the side-chain smart contract that is recorded on the main chain 100.

In some embodiments, the recovery rules comprise an indication of a party, or parties, that are able to add blocks to the side chain 200. This may be of particular use when halting is determined in the side chain and a legitimate party can be requested to add a block to the side chain. Such a legitimate party may be identified in a side chain smart contract on the main chain and/or may be identified from past behaviour.

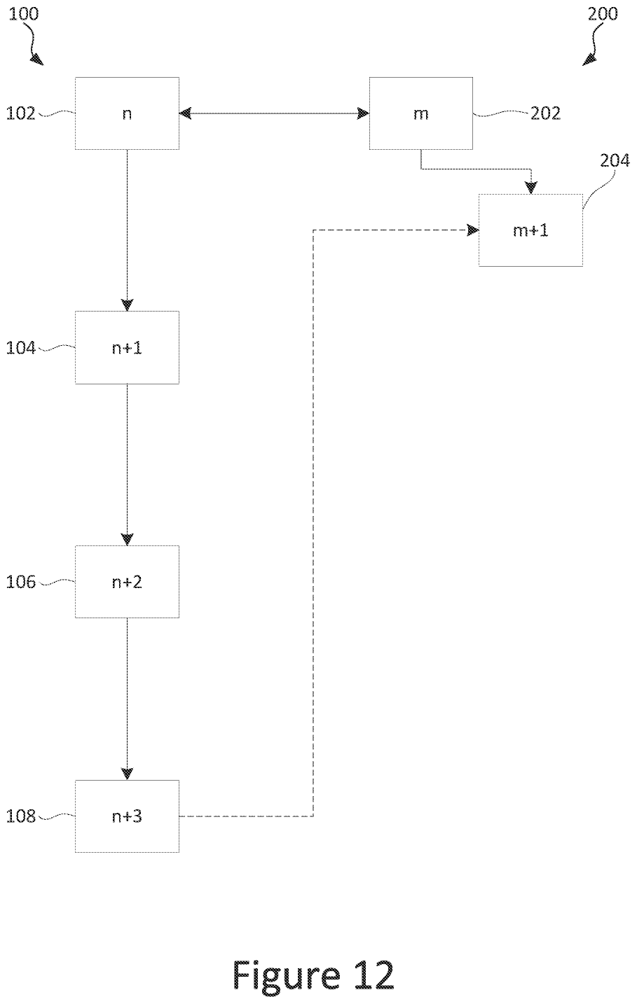

Referring to FIGS. 11 and 12, there is described a method 70 of identifying a halting of the side chain 200.

In a first step 71, a block of the main chain 100 is identified. This block of the main chain is typically a block of the main chain that does not reference a block of the side chain. This first step may also comprise referencing a number of blocks of the main chain that do not reference the side chain.

Equally, the first step 71 may comprise identifying a block of the side chain 200. This may be the last block of the side chain that is recorded on the main chain 100.

Referring to FIG. 12, there may be stored in the nth block 102 of the main chain a reference to the mth block 202 of the side chain and the identification may be identification of the nth block of the main chain and/or the mth block of the side chain. Equally, the identification may be of the (n+1) the block 104 of the main chain and/or the (n+2) the block 106 of the main chain, which blocks do not reference blocks of the side chain.

In a second step 72, it is determined whether an invalidity proof has been submitted for the identified block. This typically comprises a node of the main chain 100 identifying the receipt of an invalidity proof (e.g. a reference to the identified block).

In a third step 73, it is determined whether a challenge period has begun. While the method 60 of FIG. 9 has consider a limited challenge period that expires after a number of blocks, where a halting invalidity proof is submitted, the challenge period typically relates to a minimum block depth on the main chain that must occur before an invalidity proof can be submitted.

Referring to FIG. 12, and using a challenge period of two blocks, there may be a requirement for two blocks of the main chain 100 to not contain a reference to the side chain 200 (or to a new block of the side chain) before a halting invalidity proof can be checked by a node of the main chain. Therefore, a halting invalidity proof relating to the (n+1)th block 104 of the main chain may be considered by a node proposing and/or validating the (n+3)th block 108 of the main chain.

As with the method 60 of FIG. 10, the third step 73 may occur before the second step 72.

In a fourth step 74, it is determined whether the invalidity proof is successful. This typically comprises a node identifying that no blocks of the side chain have been added to the main chain for a certain number of blocks. Equally, the invalidity proof may identify that no transactions of the side chain have been recorded on the main chain (e.g. malicious actors may have added empty blocks to the side chain that are then recorded on the main chain) and/or the invalidity proof may identify that a threshold number of transactions/blocks of the side chain have not been recorded on the main chain in a given period.

Referring to FIG. 12, where the invalidity proof refers to the (n+1)th block 104 of the main chain, the node proposing and/or validating the (n+3)th block 108 of the main chain 100 may identify that no blocks of the side chain have been recorded in the (n+1)th block of the main chain or the (n+2)th block 106 of the main chain.

In a fifth step 75 and a sixth step 76, that are comparable to the sixth step 66 and the seventh step 67 of the method of FIG. 9, recovery rules are determined and recovery information is included on the main chain 100. In particular, recovery rules may be determined from the side chain smart contract and recovery information may then be included on the side chain smart contract. This recovery information may specify a proposer for another block of the side chain.

Referring to FIG. 12, the node may specify a proposer for a block of the side chain in the (n+3)th block 108 of the main chain 100. The proposer is then able to add a (m+1)th block 204 to the side chain.

The recovery information may also comprise information about eligible participants in the addition of further blocks of the side chain 200. Where the side chain has halted, this may be a result of malicious actors refusing to propose and/or validate new blocks. The recovery information may remove these malicious actors from a pool of eligible participants so that the remaining, honest, participants are able to add further blocks to the side chain.

The disclosed methods may be implemented where the main chain 100 is deemed to be more secure than the side chain 200. This may be the case where the main chain comprises a blockchain based on proof of work, such as Bitcoin and/or Bitcoin SV, and the side chain comprises a blockchain based on proof of stake. In this situation, the proof of stake side chain is able to add blocks, and record transactions, more rapidly than the proof of work blockchain. However, the proof of stake side chain may be vulnerable to centralisation (since with a proof of stake system parties that have a higher stake typically receive greater mining rewards, which can lead to relatively few parties holding large stakes). Therefore, the more secure proof of work main chain provides additional security to the proof of stake side chain. A malicious actor has no incentive to take control of the side chain since any fraudulent transactions will be reversed on the submission of an invalidity proof to the main chain.

It will be appreciated that the mechanism for identifying invalidity (e.g. using invalidity proofs) is advantageous even when recovery information is not provided thereafter. Similarly, the method for providing recovery information is advantageous even where a mechanism other than invalidity proofs is used to determine when to recover.

### Side Chain Smart Contract

The detailed description has referred in many places to a side chain smart contract that is recorded on the main contract. Such a smart contract may record information relating to the side chain, such as blocks of the side chain, consensus rules of the side chain, and functions relating to the side chain.

More generally, information is stored on the main chain that relates to the side chain. In order for this information to be easily identified, the information may be stored with an identifier. For example, the information may be stored on a single account of an account model blockchain and/or in a certain format or in relation to a certain UTXO on a UTXO model blockchain.

In order to provide a persistent identifier on a UTXO blockchain (where UTXOs may be burned after use), an unlocking script of a first UTXO on the main chain 100 may be arranged to require an identifier to be included in a separate UTXO in order to use the first UTXO. In this way, the identifier can be persistently included on a UTXO blockchain. A method of forcing the unlocking script of an input of a UTXO transaction to provide information on that transaction is described in more detail in WO 2018/215871 and WO2018215873. Further relevant methods for referencing information in the UTXO transaction in an unlocking script of that transaction are described in applications: WO2019043538; WO2018215876; WO2018215947; WO2019034983; WO2018215875; WO2019034959; and WO2018215872.

It will be appreciated that, as well as storing the information along with an identifier, the information may be stored with one or more features of a smart contract, such as a number of functions. These features can be stored with reference to the same identifier.

### Alternatives and Modifications

While the detailed description has described an implementation with the main chain 100 and the side chain 200, it will be appreciated that the implemented methods may be used in a system with any number of chains. As examples:
A plurality of side chains may be referenced on the main chain, where, for example, consensus rules and/or recovery information for each side chain are recorded on the main chain.
A further side chain may be referenced on the side chain, where, for example, consensus rules and/or recovery information for the further side chain are recorded on the side chain. This information relating to the further side chain may then be recorded on the main chain (since references to the side chain are recorded on the main chain).

While the detailed description has primarily considered the transfer of a digital asset, it will be appreciated that more generally ‘transactions’ may relate to the storage of any form of information. The main chain 100 and side chain 200 may for example store information relating to the behaviour of a party.

The information stored on the main chain 100 and/or the side chain 200 may be used to present an output to a user and/or to trigger an alarm. For example, the presence of a particular record on the blockchain may result in an alert being generated and displayed to a relevant party. Further, one or more parties may be able to view records stored on the blockchain(s), where these records may inform decisions made by those parties. As examples, the records may enable governments to enforce laws, parents to supervise the activities of their children, or companies to develop more efficient products. In general, the main chain 100 and/or the side chain 200 enables parties to take action based on recorded information, where this information is typically recorded in an immutable manner.

While the detailed description has primarily given examples with reference to Bitcoin, it will be appreciated that the disclosed systems and methods are equally applicable to other blockchain implementations, where appropriate modifications may be required to take into account differing operation codes.

While the detailed description has primarily described the methods being applied to blockchains, it will be appreciated that the methods and systems described herein may be applied to any public consensus network (PCN) and/or distributed consensus network (DCN), e.g. blockchains, graphchains, Directed Acyclic Graph (DAG), Avalanche, and the internet of things. In such embodiments, the PCN may not comprise blocks, so that where information has been described as being contained in a block or a block header, more generally such information may be provided in any format relating to the addition of information to a PCN.

As an example, as well as considering a block being proposed for addition to the side chain 200 in dependence on information in a block of the main chain 100, the present disclosure also considers information being proposed for addition to a first public consensus network in dependence on information in a second public consensus network.

It will be understood that the present invention has been described above purely by way of example, and modifications of detail can be made within the scope of the invention.

Reference numerals appearing in the claims are by way of illustration only and shall have no limiting effect on the scope of the claims.

1. A computer-implemented method of outputting a transmission to a second node of a first blockchain, the method being performed by a first node of the first blockchain, the method comprising:
identifying a block of a second blockchain; and
including in a proposal block for the first blockchain a reference to the identified block of the second blockchain only when:
the identified block of the second blockchain extends the second blockchain; and/or
the identified block of the second blockchain exceeds a threshold probability of finality; and
transmitting the proposal block to the second node.

2. The method of claim 1, wherein determining that the identified block extends the second blockchain comprises determining that the identified block is a descendent of a block of the second blockchain previously referenced in the first blockchain.

3. The method of claim 1, wherein the threshold probability of finality relates to one or more of:
a depth of the identified block in the second blockchain;
a stake held by signatories of the identified block; and
a probability of a block not being orphaned.

4.-5. (canceled)

6. The method of claim 1, comprising:
transmitting the proposal block to one or more other nodes; and/or
outputting the proposal block, information relating to the proposal block, and/or a transaction of the proposal block.

7. (canceled)

8. The method of claim 1, comprising including in the block of the first blockchain one or more references to the blocks of second blockchain such that each block of the second blockchain is referenced by, and/or contained in, the first blockchain.

9. The method of claim 1, further comprising determining that a value relating to the header, and/or a hash of the header, of the identified block meets a difficulty threshold and/or that signatures in the header of the identified block meet a stake threshold.

10.-11. (canceled)

12. The method of claim 1, wherein including the reference in the first blockchain comprises including the reference in dependence on, and/or in relation to, an identifier in the first blockchain.

13. The method of claim 1, wherein the first blockchain is based on proof of work and/or the second blockchain is based on proof of stake.

14. The method of claim 1, wherein the node receives a reward for the inclusion of the reference, wherein:
the reward relates to the first blockchain and/or the second blockchain; and/or
the reward comprises an amount of a cryptocurrency relating to the first blockchain and/or the second blockchain.

15. The method of claim 1, wherein identifying the block of the second blockchain comprises one or more of;
receiving an indication of the block from a node of the second blockchain; and
identifying a block of the second blockchain that exceed a threshold probability of finality.

16. (canceled)

17. The method of claim 1, further comprising verifying and/or checking a feature of the identified block.

18.-19. (canceled)

20. The method of claim 1, wherein some or all of the consensus rules and/or some or all of the transaction requirements for the second blockchain are defined in the first blockchain.

21. (canceled)

22. The method of claim 1, comprising including in the proposed block an indication of a legitimate block and/or fork of the second blockchain.

23.-24. (canceled)

25. The method of claim 1, comprising including a transaction in the proposed block relating to the second blockchain, wherein the transaction is arranged to cause a further transaction on the second blockchain.

26. (canceled)

27. The method of claim 1, comprising executing a function defined on the first blockchain based on information in the identified block of the second blockchain.

28. The method of claim 1, further comprising:
determining migration information relating to the second blockchain; and/or
determining the migration information by evaluating the identified block of the second blockchain; and/or
including in the proposal block migration information relating to the second blockchain.

29.-39. (canceled)

40. The method of claim 1, comprising including in the proposal block information identifying a legitimate block and/or fork of the second blockchain.

41. (canceled)

42. The method of claim 1, further comprising receiving an invalidity proof relating to a transaction and/or a block of the second blockchain; and including in the proposal block information relating to the invalidity proof.

43.-55. (canceled)

56. A computer-implemented method of configuring a first blockchain such that before a block is proposed by a node for addition to the first blockchain, the node:
identifies a block of a second blockchain; and
includes in a proposal block for the first blockchain a reference to the identified block of the second blockchain only when:
the identified block of the second blockchain extends the second blockchain; and/or
the identified block of the second blockchain exceeds a threshold probability of finality; and
proposes the proposal block for addition to the first blockchain.

57. (canceled)

58. A computer-implemented method of proposing information for addition to a first public consensus network, the method comprising:
identifying a piece of information of a second public consensus network; and including in a proposal block for the first public consensus network a reference to the identified piece of information of the second public consensus network only when:
the identified block of the second public consensus network extends the second public consensus network; and/or
the identified block of the second public consensus network exceeds a threshold probability of finality; and
proposing the proposal block for addition to the first public consensus network.

59.-64. (canceled)
